(19) United States
(12) Patent Application Publication
(10) Pub. No.: US 2026/0346658 A1
(43) Pub. Date: Nov. 5, 2026

(54) DEVICE AND METHOD FOR CONTROLLING A PRESSURE LEVEL IN A WHEEL

(71) Applicant: Whilx, Inc., Wilmington, DE (US)

(72) Inventors: Roi Gil KANTOR, Ramat Hasharon (IL); Guy RAUDNITZ, Ramat Gan (IL); Yuval ALONI, Yuvalim (IL)

(21) Appl. No.: 19/488,969

(22) PCT Filed: May 30, 2024
(86) PCT No.: PCT/IL2024/050534

§ 371 Date: Dec. 1, 2025

(30) Foreign Application Priority Data
Jun. 1, 2023 (IL) 303398

(51) Int. Cl. B60C 23/00

(52) U.S. Cl. CPC B60C 23/004

(57) ABSTRACT

Devices and methods which dynamically adjust tire pressure using pressure reserves stored and actively maintained within the inflated space of the tire/wheel assembly. In some examples, pressure reserves are stored by pumping gas into tanks and/or expandable envelopes mounted the circumference of the wheel. In some examples, the pumps themselves, and optionally power reserves and/or power generating devices are also positioned within the inflated space of the tire/wheel assembly. Optionally, pressurization is in stages, e.g., from a mid-pressure level in expandable envelopes up to a maximum pressure level in the tanks. Optionally volumes containing stored elevated pressures and/or partially evacuated pressures of gas are dynamically valved in response to operating conditions and events, allowing rapid pressure adjustment.

### RELATED APPLICATIONS

This application claims the benefit of priority of Israel Patent Application No. 303398, filed on Jun. 1, 2023; the contents of which are incorporated herein by reference in their entirety.

### FIELD AND BACKGROUND OF THE INVENTION

The present invention, some embodiments thereof, relates to the field of controlling pressure in a wheel, and more particularly, but not exclusively, to wheel-mounted devices controlling the air pressure level in a wheel, and methods of their use.

Pneumatic tires, as commonly used with several wheeled vehicle types, form the dynamic ground contact surface (a contact patch) through which the vehicle's motive forces and control mechanisms act to propel the vehicle, and to brake it. The contact patch is also the ground-vehicle interface through which steering forces act. Pneumatic tires also play a role in cushioning the ride of the vehicle.

Pneumatic tires are differentiated in their manufacture according to vehicle type and/or intended use conditions; in aspects including diameter, tread width, wall height, tread pattern, bead, materials, and composite construction (e.g., layering and/or patterning of different materials).

Factors commonly accounted for in tire design include the weights, speeds, and torques the tire will experience; as well as typical operating weather conditions including temperature and precipitation (e.g., snow, ice, rain, mud, and/or dry). Even for use in similar conditions, requirements for tire performance may be selected differently for different purposes: for example, targeted rolling resistance and targeted friction under acceleration and/or cornering may be traded against one another in determining a particular tire design. It is typical for cost of the tire itself (e.g., in terms of manufacturability, materials, and their amounts) to be a significant requirements factor. Environmental performance may be accounted for; e.g., how the tire contributes to noise pollution; or what and how much material the tire sheds into the environment, during and/or after its service period. Additional to these technical constraints, aesthetic preferences (e.g., for a larger or smaller wheel on which the tire is mounted, and/or for ornamentation) may influence design requirements. Design of the wheel (by a synecdoche, also referred to as the “rim”, the wheel region to which the tire is fastened) may be constrained by technical considerations of its own, influencing tire design in turn.

The design of a pneumatic tire is typically intended to meet its requirements best within a specified range of operating pressures.

### SUMMARY OF THE INVENTION

According to an aspect of some examples of the presently disclosed subject matter, there is provided a device for controlling a pressure level in a pneumatic tire/wheel assembly comprising a wheel and a tire which mounts to a rim of the wheel to define an inner space of the tire between the wheel and the tire pressurized to a first pressure in a first pressurized volume, the device comprising: one or more expandable envelopes defining a second pressurized volume, and operable to inflate to a second pressure higher than the first pressure; at least one pressure tank defining a third pressurized volume, pressurizeable to a third pressure higher than the second pressure, and in pressure-controlled fluid communication with the second pressurized volume; one or more compressors operable to pressurize at least the third pressurized volume; a controller; and a wheel mounting structure configured to mount the controller, the one or more expandable envelopes, the at least one pressure tank, and the one or more compressors within the inner space of the tire in a rotationally balanced arrangement; wherein the controller operates to regulate pressure in the first pressurized volume by initiating exchange of fluid between the third pressurized volume and at least one of the first and second pressurized volumes; and to regulate pressure in the third pressurized volume by initiating exchange of fluid with at least the second pressurized volume.

According to some examples of the presently disclosed subject matter, the controller operates to regulate pressure in the first pressurized volume by initiating exchange of fluid between the first and second pressurized volumes.

According to some examples of the presently disclosed subject matter, the controller initiates release of fluid from the third pressurized volume according to a sensed indication that pressure in the first pressurized volume is below a targeted pressure.

According to some examples of the presently disclosed subject matter, the controller initiates release of fluid from the third pressurized volume into the second pressurized volume.

According to some examples of the presently disclosed subject matter, inflation of the expandable envelopes increases pressure in the first pressurized volume.

According to some examples of the presently disclosed subject matter, the controller initiates compression of fluid from the second pressurized volume and into the third pressurized volume.

According to some examples of the presently disclosed subject matter, the controller initiates compression of fluid from the first pressurized volume into the second pressurized volume, resulting in a decrease of pressure in the first pressurized volume.

According to some examples of the presently disclosed subject matter, the second pressurized volume is defined by containment membranes of the one or more expandable envelopes, comprising mechanical actuators in contact with the containment membranes, and wherein the actuators move the containment membranes to change the volume of the second pressurized volume, initiated by the controller.

According to some examples of the presently disclosed subject matter, the controller initiates compression of the expandable envelopes by the actuators, while the controller operates the compressors to pressurize the at least one pressure tank using fluid from within the expandable envelopes.

According to some examples of the presently disclosed subject matter, the controller regulates pressure in the first pressurized volume by initiating compression or expansion of the one or more expandable envelopes by the actuators.

According to some examples of the presently disclosed subject matter, the device, further comprises at least one sensor; wherein the controller receives indications from the at least one sensor, and regulates pressure in at least one of the first, second, and third volumes according to the indications.

According to some examples of the presently disclosed subject matter, the at least one sensor comprises one or more of: a sensor located in the inner space of the tire, a sensor assembled on the tire and external to the inner space of the tire, and sensors of a vehicle comprising the tire/wheel assembly.

According to some examples of the presently disclosed subject matter, the at least one sensor is selected from, a pressure sensor, a temperature sensor, a speedometer, an accelerometer, an ohmmeter, a voltmeter, an EM emission detector, a location sensor, and a gasoline emission detector.

According to some examples of the presently disclosed subject matter, the at least one sensor comprises a location sensor, and data from the location sensor is transmitted to a communication interface in connection with a network outside of a vehicle to which the device is installed.

According to some examples of the presently disclosed subject matter, the controller operates to regulate pressure according to instructions received from a user interface.

According to some examples of the presently disclosed subject matter, the third pressurized volume is sized and configured to accept enough fluid from the first pressurized volume to reduce a pressure in the first pressurized volume by about 25%, and then return the fluid to the first pressurized volume, without exceeding an upper pressure of about 150 PSI, and without going below pressure of the first pressurized volume.

According to some examples of the presently disclosed subject matter, the third pressurized volume is sized and configured to accept enough fluid from the first pressurized volume to reduce a pressure in the first pressurized volume by about 10%, and then return the fluid to the first pressurized volume, without exceeding an upper pressure of about 150 PSI, and without going below pressure of the first pressurized volume.

According to some examples of the presently disclosed subject matter, the wheel mounting structure attaches to a radially outward surface of the wheel.

According to some examples of the presently disclosed subject matter, the one or more expandable envelopes comprise a plurality of expandable envelopes in pressure-controlled fluid communication with the at least one pressure tank.

According to some examples of the presently disclosed subject matter, the wheel includes a waist location sized and positioned to transiently receive a bead of a first side of the tire while the tire is being installed, and the wheel mounting structure positions the device on the wheel, with the waist location unobstructed for a portion of the wheel circumference.

According to some examples of the presently disclosed subject matter, the wheel mounting structure positions the device where it is in contact with a bead of a second side of the tire.

According to some examples of the presently disclosed subject matter, the one or more compressors include a pistons having a crown with an aspect ratio larger than 3:1.

According to some examples of the presently disclosed subject matter, the device includes an evacuated pressure tank evacuated to a pressure below the first pressure; and the controller operates to reduce pressure in the first pressurized volume by releasing fluid from one or both of the first and second pressurized volumes into the evacuated pressure tank.

According to an aspect of some examples of the presently disclosed subject matter, there is provided a device storing elevated pressure in a pneumatic tire/wheel assembly comprising a wheel and a tire which mounts to a rim of the wheel to define an inner space of the tire between the wheel and the tire, the device comprising: one or more pressurizeable compartments enclosing a volume within the inner space, pressurizeable to a pressure higher than a surrounding inflation pressure of the inner space, and configured to store the higher pressure until release; at least one powered pressurization pump, also positioned within the inner space, which compresses fluid and transmits it for storage in the one or more pressurizeable compartments; and a controller, configured to initiate release the stored pressure from the one or more pressurizeable compartments upon receiving an indication for pressure release, wherein the release of stored pressure adjusts the inflation pressure of the inner space.

According to some examples of the presently disclosed subject matter, the one or more pressurizeable compartments comprise an expandable envelope.

According to some examples of the presently disclosed subject matter, the one or more pressurizeable compartments comprise a pressure tank.

According to some examples of the presently disclosed subject matter, the pressure tank comprises a hard-walled enclosure capable of containing at least 100 PSI of absolute pressure.

According to some examples of the presently disclosed subject matter, the powered pressurization pump is powered from a power source also located within the inner space.

According to some examples of the presently disclosed subject matter, the powered pressurization pump operates while the tire/wheel assembly rotates.

According to some examples of the presently disclosed subject matter, the power source stores electrical energy.

According to some examples of the presently disclosed subject matter, the electrical energy the power source stores is generated by harvesting mechanical energy due to rotation of the tire/wheel assembly.

According to some examples of the presently disclosed subject matter, the mechanical energy is harvested at a generating power of less than 1 W.

According to some examples of the presently disclosed subject matter, the power source stores less than 10 kJ of electrical energy.

According to some examples of the presently disclosed subject matter, the one or more pressurizeable compartments comprise at least one expandable envelope, and at least one pressure tank pressurizeable by the at least one powered pressurization pump to a pressure higher than the at least one expandable envelope contains.

According to some examples of the presently disclosed subject matter, the at least one pressure tank is pressurized by the at least one powered pressurization pump starting from fluid pressurized within the at least one expandable envelope.

According to some examples of the presently disclosed subject matter, the controller is configured to operate the device for off-road driving by initiating a reduction in inflation pressure of the tire/wheel assembly, and then initiating restoration of the inflation pressure, using the one or more pressurizeable compartments and the at least one powered pressurized pump.

According to some examples of the presently disclosed subject matter, the controller initiates reduction in the inflation by at least 20%, before restoring it again.

According to some examples of the presently disclosed subject matter, the controller initiates the reduction in inflation pressure upon receiving an indication of off-road driving conditions from a sensor of a vehicle on which the tire/wheel assembly is installed.

According to some examples of the presently disclosed subject matter, the controller initiates the reduction of inflation pressure in a plurality of stages, each stage being initiated in response to a respective the indication of off-road driving conditions.

According to some examples of the presently disclosed subject matter, the respective indications of off-road driving conditions comprise indications of travel over different road conditions.

According to some examples of the presently disclosed subject matter, the device reduces the inflation at least in part by releasing fluid from within the inner space to ambient pressure.

According to some examples of the presently disclosed subject matter, the device reduces the inflation at least in part by moving fluid from the surrounding inflation pressure of the inner space into the one or more pressurizeable compartments.

According to some examples of the presently disclosed subject matter, the at least one powered pressurization pump performs deflation at least in part by pumping fluid from the surrounding inflation pressure of the inner space into the one or more pressurizeable compartments.

According to some examples of the presently disclosed subject matter, the at least part of the restoration of inflation comprises allowing fluid to flow from the one or more pressurizeable compartments into the surrounding inflation pressure of the inner space, due to a higher pressure contained by the one or more pressurizeable compartments.

According to some examples of the presently disclosed subject matter, the at least part of the reduction in inflation pressure comprises allowing fluid to flow from the surrounding inflation pressure of the inner space into the one or more pressurizeable compartments, due to a lower pressure contained by the one or more pressurizeable compartments.

According to some examples of the presently disclosed subject matter, the at least part of the restoration of inflation comprises pumping fluid into the surrounding inflation pressure of the inner space from a lower pressure source of the fluid.

According to some examples of the presently disclosed subject matter, the lower pressure source of the fluid comprises at lest one of the one or more pressurizeable compartments.

According to some examples of the presently disclosed subject matter, the lower pressure source of the fluid comprises ambient pressure.

According to an aspect of some examples of the presently disclosed subject matter, there is provided a device storing elevated pressure in a pneumatic tire/wheel assembly comprising a wheel and a tire which mounts to a rim of the wheel to define an inner space of the tire between the wheel and the tire, the device comprising: one or more hard-walled pressure tanks, sized and rated to enclose, overall, gas comprising at least 15% of an amount of gas which inflates the tire/wheel assembly to a manufacturer-recommended normal operating pressure of the tire; a controller, configured to release gas from the one or more hard-walled pressure tanks; and a mounting structure, configured to position the controller and one or more hard-walled tanks on the wheel in rotationally balanced positions.

According to some examples of the presently disclosed subject matter, the one or more hard-walled tanks are sized to fit within a space defined between rims of the wheel.

According to an aspect of some examples of the presently disclosed subject matter, there is provided a method of storing elevated pressure in a pneumatic tire/wheel assembly comprising a wheel and a tire which mounts to a rim of the wheel to define an inner space of the tire between the wheel and the tire, the method comprising: within one or more expandable envelopes enclosing a volume within the inner space, compressing fluid to a first pressure higher than a surrounding inflation pressure of the inner space; and within a pressure tank also within the inner space, compressing fluid from within the one or more expandable envelopes to a second pressure higher than the first pressure.

According to some examples of the presently disclosed subject matter, the compressing fluid to the first pressure comprises using actuators to reduce a volume of the one or more expandable envelopes, wherein the actuators operate by moving a containment membrane of the expandable elements while in contact with the containment membrane.

According to some examples of the presently disclosed subject matter, the compressing fluid to the second pressure comprises using a compressor.

According to an aspect of some examples of the presently disclosed subject matter, there is provided a compressor having a piston crown with an aspect ratio of at least 3:1, mounted between rims of a wheel configured to receive a pneumatic tire; wherein the compressor is interconnected with one or more pressure tanks, also mounted between the rims of the wheel, sized to hold a volume of at least 5% of a total overall volume enclosed when a tire is mounted to the wheel.

According to some examples of the presently disclosed subject matter, the piston reciprocates at an orientation which is within about 15° of perpendicular to a radial direction from a center of the wheel, when mounted thereto.

According to some examples of the presently disclosed subject matter, the compressor lies flat enough against the wheel that the piston does not extend radially beyond the rims of the wheel.

According to some examples of the presently disclosed subject matter, the piston reciprocates at an orientation which is within about 15° of perpendicular to a radial direction from a center of the wheel.

According to an aspect of some examples of the presently disclosed subject matter, there is provided a device for storing pressure within a pressurized volume of a pneumatic tire between the tire and wheel to which the tire is mounted, the device comprising: one or more expandable envelopes in the tire's pressurized volume; at least one pressure tank in pressure-controlled fluid connection with the one or more expandable envelopes; and a controller, which operates to initiate release of pressurized fluid in the pressure tank into the one or more expandable envelopes.

According to some examples of the presently disclosed subject matter, the controller operates to initiate release of pressurized fluid in the one or more expandable envelopes into the tire's pressurized volume.

According to an aspect of some examples of the presently disclosed subject matter, there is provided a device for controlling a pressure level in a pneumatic tire/wheel assembly comprising a wheel and a tire which mounts to a rim of the wheel to define an inner space of the tire between the wheel and the tire, the device including one or more expandable envelopes, each respectively comprising: a containment membrane defining a separately pressurized volume within the inner space; and one or more actuators engaged with the containment membrane; wherein the one or more actuators move the containment membrane to modify a volume of the expandable envelope and adjust a pressure of the separately pressurized volume.

According to some examples of the presently disclosed subject matter, the one or more actuators are anchored to the containment membrane, and modify the volume by adjusting their length.

According to some examples of the presently disclosed subject matter, the one or more actuators press upon the containment membrane, and modify the volume by changing how much they press.

According to an aspect of some examples of the presently disclosed subject matter, there is provided the device, comprising a plurality of expandable envelopes, radially arranged within the inner space to rotationally balance each other.

According to some examples of the presently disclosed subject matter, the device comprises a controller which operates the actuators.

According to an aspect of some examples of the presently disclosed subject matter, there is provided the device, wherein the controller operates the actuators in rotationally balanced sets, such that changes in their volumes are coordinated to avoid unbalancing rotation of the tire/wheel assembly.

According to some examples of the presently disclosed subject matter, the device comprises at least two different sets of rotationally balanced expandable envelopes.

According to some examples of the presently disclosed subject matter, the expandable envelopes expand in a direction within about 15° of perpendicular to the radial direction, substantially without expanding radially.

According to some examples of the presently disclosed subject matter, the controller is configured to receive indications of changes in wheel vibration in response to operation of the actuators, and adjust actuation to reduce wheel vibration accordingly.

According to some examples of the presently disclosed subject matter, the controller is configured to deactivate use of one of the at least two different sets of rotationally balanced expandable envelopes, in case actuation for one of the expandable envelopes in the set fails.

According to an aspect of some examples of the presently disclosed subject matter, there is provided a method of managing pressure in a rotating pneumatic tire of a vehicle, the method comprising: receiving an indication of an emergency maneuvering occurring; and adjusting pressure in the pneumatic tire to a targeted emergency maneuvering pressure before the end of the emergency maneuvering; wherein the adjusting comprises moving fluid within the pneumatic tire between a higher-pressure region and a lower-pressure region.

According to some examples of the presently disclosed subject matter, a portion of the adjusting comprises releasing fluid from within the pneumatic tire to ambient pressure.

According to some examples of the presently disclosed subject matter, the method comprises moving fluid within the pneumatic tire to reverse at least a portion of tire inflation pressure change occurring during the emergency braking.

According to some examples of the presently disclosed subject matter, the emergency maneuvering pressure is at least 1 PSI lower than an operating pressure of the tire before the adjusting.

According to some examples of the presently disclosed subject matter, the emergency maneuvering comprises at least one of braking and steering.

According to an aspect of some examples of the presently disclosed subject matter, there is provided a method of managing pressure in a rotating pneumatic tire of a vehicle operating at a target operating pressure, the method comprising: receiving an indication of highway driving; adjusting the target operating pressure of the rotating pneumatic tire to a new target operating pressure, in accordance with the indication; and adjusting pressure in the rotating pneumatic tire to the new target operating pressure.

According to an aspect of some examples of the presently disclosed subject matter, there is provided a method of managing pressure in a pneumatic tire of a vehicle, the method comprising: inflating the pneumatic tire to a running pressure, wherein the running pressure is selected to be higher than a steering pressure of the tire; receiving an indication of steering occurring; and reducing the pneumatic tire to the steering pressure; wherein the reducing comprises moving fluid within the pneumatic tire from a higher-pressure region inside the tire to a lower-pressure region inside the tire.

According to some examples of the presently disclosed subject matter, the method comprises operating one or more pressure pumps within the vehicle to restore pressure gradients released during the reducing.

According to some examples of the presently disclosed subject matter, the method comprises releasing higher pressure fluid from a higher-pressure region of the pneumatic tire to a partially depressurized region of the pneumatic tire, to restore at least a portion of the running pressure.

According to some examples of the presently disclosed subject matter, the method comprises operating one or more pressure pumps within the vehicle to restore pressure gradients released to restore the portion of the running pressure.

According to an aspect of some examples of the presently disclosed subject matter, there is provided a method of managing pressure in a pneumatic tire of a vehicle, the method comprising: receiving an indication of at least one of road and driving conditions; releasing a pressure gradient within a pressurized volume of the pneumatic tire, based on the received indication; and restoring the pressure gradient, using a pressure pump located within the pressurized volume of the pneumatic tire.

According to some examples of the presently disclosed subject matter, the restoring the pressure gradient uses stored electrical energy also located within the pressurized volume of the pneumatic tire.

According to some examples of the presently disclosed subject matter, the restoring the pressure gradient uses electrical energy generated by a device located within the pressurized volume of the pneumatic tire.

According to an aspect of some examples of the presently disclosed subject matter, there is provided a method of inflating fluid in a tire, the method comprising: providing an expandable envelope within a tire, the expandable envelope being provided with one or more actuators engaged with a containment membrane of the expandable envelope; and adjusting an amount of fluid in the expandable envelope against a pressure differential, while also actuating the one or more actuators to move the containment membrane and adjust a volume of the expandable element in a direction which reduces the pressure differential.

According to some examples of the presently disclosed subject matter, the adjusting pumps fluid from a volume of lower pressure into the expandable envelope at a higher pressure, and the actuating moves the containment membrane to adjust the volume of the expandable element to contain a larger volume.

According to some examples of the presently disclosed subject matter, the adjusting pumps gave to a volume of higher pressure from the expandable envelope at a lower pressure, and the actuating moves the containment membrane to adjust the volume of the expandable element to contain a smaller volume.

According to some examples of the presently disclosed subject matter, the adjusting comprises operation of a compressor, and the actuating reduces a pressure gradient against which the compressor performs work.

According to an aspect of some examples of the presently disclosed subject matter, there is provided a tire having a first manufacturer-recommended operating pressure used without a pressure control device, and a second manufacturer-recommended operating pressure used with a pressure control device.

According to some examples of the presently disclosed subject matter, the tire is, provided together with a pressure control device configured to adjust an inflation pressure of the tire while the tire is in rolling operation, to maintain the second manufacture-recommended operating pressure.

Some aspects of the invention are directed to a device for controlling a pressure level in a wheel comprising a rim and a tire, the device comprising: one or more inflatable envelopes installable in a tire inner space defined by an outer surface of the rim and inner surfaces of the tire; a pressurized gas tank, in fluid connection with the one or more inflatable envelopes; and one or more controllable mechanisms, configured to control the volume of the one or more inflatable envelopes.

In some examples, controlling the volume of one or more inflatable envelopes comprises controlling at least one of: inflation and deflation of the one or more inflatable envelopes with gas from the pressurized gas tank based on instructions received from a controller.

In some examples, the device further comprises at least one sensor, wherein the controller is configured to receive signals from the at least one sensor; and control the one or more controllable mechanisms based on the received signal. In some examples, the sensors is at least one of: a sensor located in the space, a sensor assembled external to the space, or sensor of a vehicle comprising the wheel.

In some examples, the controller is configured to receive the instructions from a user interface. In some examples, the device further comprises a housing, holding at least one of, the controller, the gas tank, and the one or more controllable mechanisms and, wherein the housing is configured to be accommodated in the space. In some examples, the housing further holds the at least one sensor. In some examples, the housing is attached to the outer surface of the rim. In some examples, the at least one sensor is selected from, a pressure sensor, a temperature sensor, a speedometer, an accelerometer, ohmmeter, a voltmeter, an EM emission detector, and a gasoline emission detector.

In some examples, the one or more inflatable envelopes are attached to the outer surface of the rim. In some examples, the device comprises two inflatable envelopes fluidly connected to two opposite outlets of the pressurized gas tank.

In some examples, the controllable mechanism comprises a valve and at least one compressor fluidically connected between the one or more inflatable envelopes and the pressurized gas tank.

In some examples, the controllable mechanism comprises one or more arms powered by one or more motors configured to press or release the pressure from the one or more inflatable envelopes.

In some examples, the controllable mechanism comprises: an internal valve located between the one or more inflatable envelopes and the tank for controlling the insertion of pressurized gas into the one or more inflatable envelopes, and an external valve in fluid connection to the one or more inflatable envelopes and the surroundings of the wheel, for releasing of pressurized gas from the one or more inflatable envelopes.

Some additional aspects of the invention are related to a method of controlling a pressure level in a wheel of a vehicle, comprising: receiving a signal indicative of a pressure level in the wheel; and adjusting inflatable envelopes volume to bring pressure into a required range.

In some examples, adjusting the volume of the inflatable envelope comprises controlling one or more controllable mechanisms to one of: provide pressurized gas from a pressurized gas tank to one or more inflatable envelopes if the pressure level is below a first threshold level; release or extract pressurized gas from the one or more inflatable envelopes if the pressure level is above a second threshold level, and wherein the one or more inflatable envelopes are installable in a space defined by an outer surface of a rim and an inner surface of a tire of the wheel.

In some examples, the signal indicative of the pressure level is selected from: pressure, temperature, weight, speed, acceleration, posture, and change in environmental conditions. In some examples, the method further comprises receiving an indication that the vehicle is driving, and wherein controlling the one or more controllable mechanisms is also based on the indication. In some examples, controlling the one or more controllable mechanisms is to elevate the pressure level in the wheel to at least a first threshold level.

Unless otherwise defined, all technical and/or scientific terms used herein have the same meaning as commonly understood by one of ordinary skill in the art to which the present disclosure pertains. Although methods and materials similar or equivalent to those described herein can be used in the practice or testing of embodiments of the present disclosure, exemplary methods and/or materials are described below. In case of conflict, the patent specification, including definitions, controls. In addition, the materials, methods, and examples are illustrative only and are not intended to be necessarily limiting.

As will be appreciated by one skilled in the art, aspects of the present disclosure may be embodied as a system, method, or computer program product. Accordingly, aspects of the present disclosure may take the form of an entirely hardware embodiment, an entirely software embodiment (including firmware, resident software, microcode, etc.) or an embodiment combining software and hardware aspects that may all generally be referred to herein as a “circuit,” “module” or “system” (e.g., a method may be implemented using “computer circuitry”). Furthermore, some embodiments of the present disclosure may take the form of a computer program product embodied in one or more computer readable medium(s) having computer readable program code embodied thereon. Implementation of the method and/or system of some embodiments of the present disclosure can involve performing and/or completing selected tasks manually, automatically, or a combination thereof. Moreover, according to actual instrumentation and equipment of some embodiments of the method and/or system of the present disclosure, several selected tasks could be implemented by hardware, by software or by firmware and/or by a combination thereof, e.g., using an operating system.

For example, hardware for performing selected tasks according to some embodiments of the present disclosure could be implemented as a chip or a circuit. As software, selected tasks according to some embodiments of the present disclosure could be implemented as a plurality of software instructions being executed by a computer using any suitable operating system. In some embodiments of the present disclosure, one or more tasks performed in method and/or by system are performed by a data processor (also referred to herein as a “digital processor”, in reference to data processors which operate using groups of digital bits), such as a computing platform for executing a plurality of instructions. Instruction executing elements of the processor may comprise, for example, one or more microprocessor chips, ASICs, and/or FPGAs. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well. Any of these implementations are referred to herein more generally as instances of computer circuitry.

Any combination of one or more computer readable medium(s) may be utilized for some embodiments of the present disclosure. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device. A computer readable storage medium may also contain or store information for use by such a program, for example, data structured in the way it is recorded by the computer readable storage medium so that a computer program can access it as, for example, one or more tables, lists, arrays, data trees, and/or another data structure. Herein a computer readable storage medium which records data in a form retrievable as groups of digital bits is also referred to as a digital memory. It should be understood that a computer readable storage medium, in some embodiments, is optionally also used as a computer writable storage medium, in the case of a computer readable storage medium which is not read-only in nature, and/or in a read-only state.

Herein, a data processor is said to be “configured” to perform data processing actions insofar as it is coupled to a computer readable medium to receive instructions and/or data therefrom, process them, and/or store processing results in the same or another computer readable medium. The processing performed (optionally on the data) is specified by the instructions, with the effect that the processor operates according to the instructions. The act of processing may be referred to additionally or alternatively by one or more other terms; for example: comparing, estimating, determining, calculating, identifying, associating, storing, analyzing, selecting, and/or transforming. For example, in some embodiments, a digital processor receives instructions and data from a digital memory, processes the data according to the instructions, and/or stores processing results in the digital memory. In some embodiments, “providing” processing results comprises one or more of transmitting, storing and/or presenting processing results. Presenting optionally comprises showing on a display, indicating by sound, printing on a printout, or otherwise giving results in a form accessible to human sensory capabilities.

A computer readable signal medium may include a propagated data signal with computer readable program code embodied therein, for example, in baseband or as part of a carrier wave. Such a propagated signal may take any of a variety of forms, including, but not limited to, electro-magnetic, acoustic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present disclosure may be written in any combination of one or more programming languages, including an object-oriented programming language such as Java, Smalltalk, C++ or the like and conventional procedural programming languages, such as the “C” programming language or similar programming languages. Additionally or alternatively, sequences of logical operations (optionally logical operations corresponding to computer instructions) may be embedded in the design of an ASIC and/or in the configuration of an FPGA device. The program code may execute entirely on the user's computer, partly on the user's computer (e.g., as a stand-alone software package), partly on the user's computer and partly on a remote computer or entirely on the remote computer or server. In the latter scenario, the remote computer may be connected (physically, e.g., by optical cable and/or wire; wirelessly, e.g. by light and/or radio communication; and/or using another data transport implementation) to the user's computer through any type of network, including a local area network (LAN) or a wide area network (WAN), or the connection may be made to an external computer (for example, through the Internet using an Internet Service Provider).

Some embodiments of the present disclosure may be described below with reference to flowchart illustrations and/or block diagrams of methods, apparatus (systems) and computer program products according to embodiments of the present disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer; and may not be feasible or practical for performing purely manually, by a human expert. A human expert who wanted to manually perform similar tasks, such inspecting objects, might be expected to use completely different methods, e.g., making use of expert knowledge and/or the pattern recognition capabilities of the human brain, which would be vastly more efficient than manually going through the steps of the methods described herein.

### BRIEF DESCRIPTION OF THE SEVERAL VIEWS OF THE DRAWINGS

Some embodiments of the present disclosure are herein described, by way of example only, with reference to the accompanying drawings. With specific reference now to the drawings in detail, it is stressed that the particulars shown are by way of example, and for purposes of illustrative discussion of embodiments of the present disclosure. In this regard, the description taken with the drawings makes apparent to those skilled in the art how embodiments of the present disclosure may be practiced.

In the drawings:

FIGS. 1A-1B schematically illustrate an example of a stand-alone pressure control device for controlling a pressure level and the device assembled in a tire/wheel assembly, according to some examples of the presently disclosed subject matter;

FIGS. 1C-1D schematically illustrate other examples of pressure control device for controlling a pressure level in a tire, according to some examples of the presently disclosed subject matter;

FIGS. 2A, 2B, 2C, 2D, 2E, 2F and 2G schematically illustrate examples of a stand alone pressure control device for controlling a pressure level in a tire, as assembled in a tire/wheel assembly, according to some examples of the presently disclosed subject matter;

FIG. 3A schematically illustrates a pressure control device for controlling a pressure level in a tire, according to some examples of the presently disclosed subject matter;

FIGS. 3B-3D schematically illustrate, in cross-section, arrangements of a compressor and one or more valves in relation to a pressure control device for controlling a pressure level in a tire, according to some examples of the presently disclosed subject matter;

FIGS. 3E-3F schematically illustrate compressor in different cross-sectional views, according to some examples of the presently disclosed subject matter;

FIGS. 4A-4B schematically illustrate a cross-section of an envelope fitted with a plurality of arms which are operable to compact or expand a lumen of the envelope, according to some examples of the presently disclosed subject matter;

FIG. 4C also schematically illustrates a cross-section of an envelope fitted with a plurality of arms which are operable to compact or expand a lumen of the envelope, according to some examples of the presently disclosed subject matter;

FIGS. 5A-5B each schematically show a cross section of an envelope of a pressure control device, according to some examples of the presently disclosed subject matter;

FIGS. 6A-6D each schematically show a cross section of an envelope of a pressure control device, according to some examples of the presently disclosed subject matter;

FIGS. 7A-7B each schematically show a cross section of an envelope of a pressure control device, according to some examples of the presently disclosed subject matter;

FIGS. 8A-8E illustrate examples of arms used with a pressure control device, according to some examples of the presently disclosed subject matter;

FIG. 9 is a block diagram of pressure control device for controlling a pressure level in the tire according to some examples of the presently disclosed subject matter;

FIGS. 10A, 10B, and 10C are block diagrams of various controllable mechanisms according to some examples of the presently disclosed subject matter;

FIG. 11A is a flowchart of a method of controlling a pressure level in a tire of a vehicle according to some examples of the presently disclosed subject matter; and

FIG. 11B which is a flowchart of another method of controlling a pressure level in a tire of a vehicle according to some examples of the presently disclosed subject matter.

### DESCRIPTION OF SPECIFIC EMBODIMENTS OF THE INVENTION

The present invention, some embodiments thereof, relates to the field of controlling pressure in a wheel, and more particularly, but not exclusively, to wheel-mounted devices controlling the air pressure level in a wheel, and methods of their use.

### Overview

A broad aspect of some examples of the presently disclosed subject matter relates to devices and methods for controlling a pressure level in an inflated pneumatic tire of a vehicle (herein, a “tire”). In some examples, the device operates automatically, for example, when an indication of a pressure drop in a pressure-controlled tire is received from a sensor. Additionally or alternatively, the device operates on demand; for example, based on instructions from the driver to reduce pressure in the tire prior to going off-road.

In some examples, a pressure control device is severely limited in available power and/or energy during at least a portion of its activity; for example, limited in the total amount of energy stored for its own immediate access, limited in the rate at which power can be generated for storage or use, and/or limited in the rate at which stored or generated power can be used. These limitations potentially arise insofar as pressure control devices operate from within a thick-walled, rotating tire, since this can make commonly-used methods of wired, contact, and/or wireless electrical power transmission weak, unreliable, or otherwise unsatisfactory.

An aspect of some examples of the presently disclosed subject matter relates to devices which include one or more pressurizeable compartments, along with at least one powered pressurization pump which operates to pressurize the pressurizeable compartment(s); both being operably interconnected to adjust pressure in the pressurizeable compartment(s), and configured for placement within the pressurized volume of a tire/wheel assembly (the “tire's inner space”, defined between the wheel and the tire).

The one or more pressurizeable compartments comprise one or more of an expandable envelope and a pressure tank (e.g., as these are described herein below). Optionally, both are provided. In particular, an expandable envelope is distinguished from a pressure tank by having a variably-sized enclosed volume, e.g., variable by at least 25%, and preferably by a factor of two or more. The expandable envelope may comprise a flexible and optionally elastically expanding containment membrane, which flexes and/or expands to adjust its volume. Optionally, one or more actuators (also referred to herein as “arms”) are provided, which engage with the containment membrane and move to adjust the volume.

Optionally, a pressure tank is a hard-walled enclosure capable of containing at least 100 PSI of absolute pressure, and/or a pressure at least 50 PSI above the manufacturer-recommended inflation pressure of the tire and/or tire/wheel assembly. In some examples, the pressure tank is capable of storing 150 PSI of absolute pressure, or another pressure, for example as described herein in relation to pressure tanks. The hard-walled enclosure is preferably inflexible; e.g., its enclosed volume remains substantially unchanged under pressurization; or at least does not change by more than about 1%. Pressurized tanks, in some examples, are sized to fit within a volume defined between rims of the wheel; that is, the pressurized tanks do not protrude above a line extending between the two closest regions of the wheel's two rims.

The one or more pressurizeable compartments, in some examples, are pressurizeable to a pressure higher (e.g., by at least 3 PSI) than a surrounding inflation pressure of the tire's inner space (e.g., the manufacturer-recommended inflation pressure of the tire). With larger pressurization differences, potentially larger ranges of pressure adjustment of the tire's inner space are obtained (e.g., for scenarios and/or within ranges described herein), separate from adjustments which resort to the use of gas from the ambient environment, and/or which vent gas to the ambient environment.

The at least one powered pressurization pump, in some examples, comprises a device which operates to increase a pressure differential between the one or more pressurizeable compartments and a reference pressure. The reference pressure may be the actual and/or recommended inflation pressure of the tire, gas pressure at a source of the gas being pumped, and/or an initial gas pressure. For example, gas may be transferred from a lower pressure volume into a pressurizeable compartment (i.e., without a fully compensating increase in volume, when temperature is constant), or an envelope may be compressed without transfer of gas. It is not excluded that the pressurizeable compartment contains the lower-pressure volume, or that the pumping comprises expanding the pressurizeable compartment without fully compensating introduction of additional gas (e.g., temperature being treated as constant). The at least one pressurization pump may comprise a compressor (a term further explained herein), or it may comprise the expandable envelope itself, along with actuators which manipulate its volume.

In some examples, power for the at least one powered pressurization pump is stored by and/or generated from a device which is affixed to the tire/wheel assembly so that it turns with it, and/or is contained within the tire's pressurizeable inner space. For example, an energy harvesting device may be used to generate power from mechanical motion of the tire/wheel assembly, and/or a battery, supercapacitor bank, fuel cell, or other energy storage device may be positions where its power is available for use by the at least one powered pressurization pump.

In some examples, a controller operates to regulate inflation pressure of the tire/wheel assembly (e.g., pressure in a portion of the inner space which is outside the pressure regulating device's pressurizeable compartments), by initiating release of pressure from the one or more pressurizeable compartments. Release of pressure may be initiated in response to an indication of a need to adjust the inflation pressure. For example, the indication may be an indication of a leak, a user command, a sensed (e.g., current) inflation pressure, an acceleration, an indication of road conditions (e.g., of weather and/or road conditions), an indication of driving status (e.g., highway driving and/or emergency maneuvering), and/or another indication; for example, any such indication and/or sensor data type as described herein. Release of pressure optionally increases inflation pressure (e.g., when the one or more pressurization compartments include a pressure stored above the inflation pressure), and/or decreases inflation pressure (e.g., when the one or more pressurization compartments include a pressure stored below the inflation pressure). Scenarios for inflation pressure adjustment are described hereinbelow.

Preferably, components of the pressure regulating device are mounted around a circumference of the wheel of the tire/wheel assembly in a rotationally balanced configuration, e.g., rotationally balanced so that any residual imbalance is within limits of standard tire balancing procedures to correct, and/or small enough that it is negligible (e.g., comparable to residual imbalance in a well-balanced tire). Mounting and rotational balance capabilities are implemented by the mounting structure of the device, which may incorporate the structure of functional pressurizeable and/or pressure controlling components themselves, e.g., as mentioned above; and/or other such as housings, connectors, belts, bands, straps, and/or fasteners.

### Issues of Pneumatic Tire Inflation Pressure

The air pressure in a pneumatic tire is an important mediator of the size of the tire's surface in contact with the road; referred to herein as the tire's “contact patch”.

At least within design limits of a tire, a larger contact patch resulting, e.g., from a relatively lower tire pressure, potentially results in relatively greater friction with the road, which can help maintain driving stability, particularly in critical situations such as sudden stops and/or slick (e.g., icy, wet, and/or oily) road conditions. However, a larger contact patch also generally corresponds to increased inefficiencies such as increased rolling resistance. Furthermore, excessive deflation potentially results in an opposite effect; e.g., due to inward bowing of the tread.

Beyond these considerations: insofar as a pneumatic tire is designed for specific performance characteristics, inflation of the tire to a pressure outside of its specified operating range potentially degrades its performance. For example, both overinflation and underinflation can result in wear which reduces the safe service period of a tire, e.g., by causing the tire to operate in a shape which wears unevenly. An under-inflated tire potentially undergoes excessive flexing, and as a result may be damaged, e.g., by overheating. Uneven tire deflation can result in differences in effective tire circumference, with associated excess wear.

Furthermore, a major cause for losing steering control while driving a vehicle is loss of air pressure in one or more tires of the vehicle. This potentially contributes to accidents. A loss of 1 to 3 pounds per square inch (PSI, roughly equivalent to 0.069 bars of pressure) per month is normal; however, if not attended to, this normal loss can contribute to loss of steering control, and potentially mechanical failure of the tire itself.

For example, a tire deflated more than 25% from the recommended pressure may degrade performance enough to increase the likelihood of a tire-related accident by a threefold with respect proper inflation pressure. This potentially includes one or both of effects degrading the dynamic performance of a tire during sudden maneuvers, and failure of the tire itself (e.g., blowout and/or tread separation).

For losses of pressure noticed during driving, a standard solution includes stopping the driving and inflating and/or replacing/fixing the tire. However, driving the car to the puncture repair station with a punctured tire is dangerous, while the roadside stop itself may include risk to the driver and passengers from oncoming traffic.

When driving off-road (e.g., relatively slowly on rough terrain), it may actually be appropriate to decrease the pressure in the tires in order to increase the stability of the vehicle and prevent one or more tires from bogging in sand or in mud. Pressure is preferably increased again for driving on normal road surfaces. Pressure reductions of around 25% are typical for such conditions. In some examples, the pressure reduction is in response to an indication of travel over off-road terrain; for example, vehicle operator selection; or a form of vibration detection such as measurement of suspension movement amplitudes, pressure spikes in one or more tires, and/or acceleration sensing. In some examples, a plan for off-road travel is determined in advance from a planned route, e.g., a route determined by a navigation system of a vehicle to which the device is installed. Optionally, operations to change tire pressure are initiated upon reaching location coordinates at which off-road travel begins, and/or in anticipation of road conditions along the planned route; e.g., a portion of active pressure storage may begin 1-60 minutes before off-road travel begins, and/or upon reaching an access road with lowered driving speeds. Optionally, some powered operations of the pressure control device are curtailed in advance of planned off-road driving, in order to reserve pressure, chemical, and/or electrical power for use in adjusting to off-road conditions, and/or reverting to standard road driving conditions again.

It should be noted that the amount of pressure change is optionally varied in stages and/or continuously over different types terrain, based, e.g., on the ruggedness of road conditions. Stages may comprise, for example, changes of 1-3 PSI. Optionally, stages are passed through in any suitable order; e.g., during a single excursion, pressure may be reduced and increased according to present and/or soon-anticipated road conditions. Initiation of stages and/or their new targeted tire pressures is optionally determined from indications such as vehicle operator selection, vehicle and/or tire sensors, advance indications of road conditions, and/or data gathered while previously travelling the terrain; for example, data gathered from sensors and/or vehicle operator selections during previous travel. In some examples, previously gathered data from the same vehicle is used. In some examples, previously gathered data from other vehicles is used; e.g., data from vehicles which share relevant sensor data, driving plans, vehicle operator selections (e.g., recommendations), and/or road condition analysis over network connections.

Tire inflation guidelines typically take into account that tire pressure ordinarily fluctuates as a function of temperature; for example, it may rise after a period of driving which warms a tire, and/or change as a function of ambient temperature. Accordingly, while the recommended optimum inflation pressure range for a tire may be selected to avoid excursions from a suitable inflation pressure, it does not necessarily result in peak performance for its design during an entire drive. This can include, for example, accepting known decreases in fuel efficiency.

Potentially, even optimal tire pressure is a dynamic function of conditions. For example, a higher inflation pressure may be more efficient-and ordinarily safe-except that it lengthens the minimum stopping distance of the vehicle for emergency braking. Accordingly, the recommended normal tire inflation pressure potentially is selected as a compromise among constraints relevant in conditions which are only occasional. Recommended tire pressure may change as a function of intended driving speed, e.g., to reduce tire heating and/or increase rolling efficiency.

An aspect of some examples of the presently disclosed subject matter relates to partially or wholly pressure-enclosed devices which operate to control pressure within a pneumatic tire/wheel assembly (herein, “tire pressure” within the “main pressurized volume” of the tire).

The devices optionally operate to increase and/or decrease tire pressure, optionally at time scales relating to any one or more of several ordinary pressure-affecting processes. Examples include: gradual (e.g., normal) losses in tire pressure over periods of weeks or months, slow-leak losses in tire pressure, and changes in tire pressure in response to temperature (environmental and/or due to tire operation). Optionally, the devices are operated to provide deliberate modification of tire pressure, e.g., to modify vehicle ride characteristics, to respond to road conditions (e.g., precipitation and/or off-road driving), and/or to respond to dynamic driving states such as cornering, acceleration/deceleration, and/or speed. In some examples, responses potentially occur with sufficient speed to modify traction in response to emergency maneuvering. For example, a tire may have an optimal efficiency pressure and an optimal traction pressure which are not identical. The system may inflate a tire to a pressure suitable for optimal efficiency under some operating conditions, but modify (e.g., reduce) pressure under other conditions (e.g., emergency conditions, and/or a different rate of travel) to an optimal traction pressure (e.g., increase or reduce it by at least 1-3 PSI, with enough response before a braking vehicle comes to a halt). In some examples, the device is configured for use with a tire and/or tire/wheel having a plurality of recommended operating pressures by sensing current operating conditions, and adjust inflation pressure to a relevant recommended operating pressure. In some examples, a tire is provided which has distinguishable recommended operating pressures, wherein switching between the recommended operating pressures uses active control of tire pressure, additionally or alternatively to pressure changes which the tire ordinarily undergoes, e.g., as a function of changes in operating temperature. In some examples, a recommended baseline tire inflation pressure is adjusted, based on the understanding that the tire will be used together with an active pressure control device. In some examples, a tire is provided with a first recommended inflation pressure for use in vehicles without pressure control systems, and a second recommended inflation pressure for use in vehicles equipped with a pressure control system.

In some examples, pressure control devices are fully contained within the pressurized volume of a tire/wheel assembly. For example, they may be secured to the outer surface of the wheel, approximately between its rims. This has potential advantages for add-on use, insofar as it potentially requires no modification of the tire, and little or potentially no modification to the wheel. Optionally, the wheel is modified with attachment hardware, although in some preferred examples, the pressure control device is self-securing. Optionally, the wheel is modified with one or more valve holes through which some examples of pressure control devices communicate with ambient pressure air. Additionally or alternatively, a device may interface with a valve attached to a wheel's normal rim hole for such a device. Additionally or alternatively, gases and volumes are maintained by the pressure control device in a fully self-contained fashion, and/or with the only direct exchange of gas during normal service being with the main pressurized volume of the tire.

In some examples, pressure control devices are powered by and/or through any one or more of a reserve battery, supercapacitor bank and/or fuel cell; an energy harvesting device which harvests energy from mechanical motions of the tire; an electrical socket (e.g., exposed via an aperture on the wheel, and used while the vehicle is stationary); electrical induction (e.g., while the vehicle is stationary, and/or using rotational motion of the wheel relative to other vehicle components); heating and conversion of heat differentials to electrical power; or another method. It is noted in particular that the rate at which useful power can be generated within and/or transmitted into the environment of a rotating tire may be severely limited by engineering constraints such as weight, safety, and/or inaccessibility (since the tire/wheel assembly is a robustly built pressure-sealed compartment). To these considerations the difficulty of the rotation itself is added. Furthermore, there may be constraints on how much power can be safely stored within the pressurized compartment of a tire/wheel assembly, and/or on what power storage devices are acceptable for use in this pressurized compartment.

Associated with some examples of the presently disclosed subject matter are a range of technical aspects related to mechanisms by means of which pressure is controlled, methods of device operation relating to control of pressure at different time scales, how reservoirs of pressurizing gas are used up and restored, how tire pressure control devices are powered and receive their power, and how pressure control devices are configured to avoid disturbances to wheel balance.

Related aspects of the present disclosure describe control systems which monitor and control pneumatic tire inflation pressure, including one or both of control at the level of an individual tire/wheel assembly, and whole-vehicle control. Furthermore, although potentially well-suited to add-on use, some examples of the tire pressure control devices of the present disclosure provide potential advantages for incorporation with a vehicle's original design.

### Pressure Control Mechanisms

Pressure control devices of the present disclosure optionally act to increase tire pressure by one or both of occupying more of the main pressurized volume of the tire (e.g., by inflating one or more sealed envelopes of the pressure device), and releasing gas into the main pressurized volume of the tire, outside of the device itself.

Pressure control devices which increase their own volume may operate according to one or more principles of operation, for example as next described.

In some examples, the volume increase is caused by and/or associated with a release of gas from a reservoir which is itself pressurized above the tire pressure (e.g., a high-pressure tank), into a sealed space which is still part of the device itself (e.g., one or more expandable envelopes). The sealed space is optionally a continuous space, or divided into compartments. Optionally at least some separate control of compartments is provided. In some examples, rather than maintaining all gas in containment by the pressure control device, at least some gas is released directly into the main pressurized volume of the tire. Optionally, all release is into the main pressurized volume.

A potential advantage of retaining at least some gas within expandable envelopes of the pressure control device is that gasses other than air can be used to elevate pressure when needed, and then scavenged for storage and re-use without mixing. Such gasses may have meaningfully different properties than air; e.g., differences in compressibility, material phase, mass, and/or temperature change as a function of pressurization. It may be a potential advantage to be able to ensure that pumping mechanisms operate with controlled and/or stable conditions of moisture, lubrication, and/or cleanliness. Another potential advantage is that a plurality of distinct pressure levels are optionally retained by the pressure control device, which potentially helps enable a greater range of pressure regulation options.

In some examples, released gas drives one or more of the envelopes of the sealed space to expand until it reaches a pressure equilibrium. This pressure equilibrium may be directly with the surrounding tire pressure of the main pressurized volume of the tire, or it may be limited by expansion limits of the containment membrane of the envelope itself. Noting that the elasticity of the sealed space walls may somewhat resist expansion, the sealed space is optionally pressurized to a pressure equal to or higher than the surrounding tire pressure.

It is a potential advantage for a rapid inflation time if there is a high-pressure tank and/or pressurized envelope that can act as a pressure reservoir. For example, inflation of the tire can then be driven by the energy of the pressurized gas itself, rather than requiring active pumping for which there may be limitations on peak power. A pre-pressurized reservoir also has the potential advantage that it allows operation without requiring the pressure control device to have direct and/or immediate access to a source of gas such as ambient pressure atmosphere.

For restoring of pressure differentials, some examples of the present disclosure include one or more active pumping mechanisms, also referred to herein as pressurizing pumps. In some examples, one of the active pumping mechanisms comprises one or more compressors, which take in gas at a relatively lower pressure, and expel it at a relatively higher pressure. However, it is potentially difficult to develop enough torque from such devices, particularly when a pressure control device operates under power-limited conditions.

Examples of compressors include devices which use cyclic movement of a piston, diaphragm, or other barrier to change the volume of a compression chamber. In such compressors, valves operate actively and/or passively in conjunction with these movements to admit lower pressure fluid (e.g., gas or liquid) when the compression chamber is larger, and expel higher pressure fluid when the compression chamber is smaller. Other types of compressors, including those with principles of operation other than a valved chamber of variable size are not excluded; for example, a peristaltic pump may be provided. Typical of compressors, at least for examples as described in the present disclosure, is the use of a large number of pressure cycles within a relatively small volume in order to pressurize a volume which is relatively larger by a large factor-e.g., at least a hundred times larger, and often larger by a factor of a thousand or more. Accordingly, for rapid pressurization, the pressure cycle time should be relatively short, e.g., a second or less (for example, less than 100 msec, less than 500 msec, or less than 750 msec). However compressor use is not limited to short-cycle time implementations.

One of the characterizing parameters of a compressor stage is its compression ratio, which is a measure of the factor by which a compressible fluid is increased in pressure and/or decreased in volume by operation of the compressor. Ignoring factors such as leakage, non-ideal fluid behavior, and attached auxiliary volumes, compression ratio may be determined, for example, by the ratio between a compression chamber's maximum and minimum volumes. Achieving a greater compression ratio (at least within a single compression stage) typically requires a compressor to apply a higher power level, at least for part of the compression cycle. This may be understood in part as a decreasing slope of the compression ratio/energy input curve (e.g., less additional compression for the same amount of energy used by the compressor, eventually reaching zero). Furthermore, there may be a non-zero threshold of energy input, below which the compressor can no longer achieve even incremental compression, such that compression stalls and/or fails to reach its designed compression ratio. Optionally, compressors may be geared to reduce this non-zero threshold. However, this potentially results in other consequences, e.g., a larger overall energy expenditure and/or time required to achieve a certain amount of pumping and/or pressurization.

Herein, the term “torque” is used with respect to the compressor's ability to perform compression, even though rotation as such is not necessarily used in all compressor designs used with examples of the present disclosure. For example, a compressor using thermal volume expansion properties may generate potentially very large peak compression forces (and potentially a very high compression ratio), even without the use of rotational motion. Compressors provided in examples may be of one or more stages; for example, single-stage, two-stage, or multistage. Stages for stroke compressors may be single-acting (e.g. compressing during just on one stroke direction) or double-acting (compressing on each stroke direction). Other features of compressors include: use of lubrication (e.g., oil-lubricated or oil-free), piston configuration (e.g., V-type, tandem position, horizontal piston, vertical piston, and/or reciprocating piston), and cooling (e.g., air-cooled or water cooled). In some examples, a balanced opposed reciprocating compressor is used; that is, masses such as pistons which reciprocate during compression are arranged in sets (e.g., pairs) with opposing motions, such that changes in rotational moment are maintained in a net balance. Optionally, gearing is provided in suitable ratios to adjust torque and/or maximum force which compressors can produce.

In some examples, volume changes of larger compartments themselves (also referred to herein as “envelopes” and “expandable envelopes”) are driven at least in part mechanically; that is, there is a contribution to volume expansion from an actuated mechanism which is distinct from either a compressor (optionally, a compressor characterized as having a 100:1 or greater ratio of storage volume to compression chamber volume), or valved release of pressure through a pressure gradient.

In some examples, such larger compartments are large enough to be useful as pressure storage in their own right; e.g., establishing a higher or lower pressure volume which can be valved open to assist in inflation or deflation of a tire. These compartments are optionally the highest pressure storage used for the fluid (typically a gas) they store. Alternatively, in some examples, such larger compartments are used as an intermediate storage stage during compression to a higher storage pressure. When the larger compartments are used in this fashion, they may be in a relatively balanced volume relationship with the highest pressure storage chambers of the device; e.g., in a ratio of 5:1 or less, and optionally larger in maximum volume than the high pressure storage tanks. Structurally, the high pressure storage tanks are differentiated from expandable envelopes by being rigid in structure. This potentially allows them to store gas at higher pressures, and/or in lower volumes. Expandable envelopes, however, optionally extend (e.g., when fully inflated) into less protected regions of the inner tire space, such as regions which might be at risk of being pressed on by the tire in the event of a puncture and loss of main tire pressure. It is a potential advantage to use more flexible pressure storage devices in this region, e.g., to reduce chances of creating a tire-internal blowout event due to damage to hard tank walls, and/or to take advantage of relatively compliant remaining envelope pressure to mitigate effects of main tire pressure loss.

The actuation mechanism, in some examples, comprises a plurality of length-extending actuators acting against an expandable pressure barrier (e.g., a membrane). An individual length-extending actuator optionally comprises, for example, a hydraulic or pneumatic actuator, a screw actuator and/or an expanding scissors-jack actuator. The expanding scissors-jack actuator is itself screw driven or hydraulically or pneumatically driven, in some examples). Optionally, actuators are cable-driven.

In some examples, volume changes are driven by squeezing a pressurized volume of an expandable envelope. For example, one or more envelopes may be positioned between two plates (or between the wheel and a plate), and its volume limited by movement of one or both of the plates, e. g., hydraulically, pneumatically, using screws (e.g., screws near a plurality of corners and/or edges of the plate), or by another means. Optionally, the plate is moved to expand (and/or allow expansion of) the volume. In place of a plate, a more flexible element such as a sheet (e.g., of polymer rubber and/or thin metal) or a net is optionally used. Pressure changing optionally addresses the whole of an envelope, or a portion of one. Optionally, envelopes are placed in pressure communication (e.g., by opening a valve), and one of them inflated by compression of the other (by whatever mechanism).

In some examples, material properties such as superelasticity and/or shape memory transitions as a function of temperature are used by actuators comprising nitinol, or another superelastic material; for example, another titanium-based alloy (e.g., with vanadium, niobium, and/or zirconium), a copper-based alloy such as copper-zinc-aluminum (Cu—Zn—Al) or copper-aluminum-nickel (Cu—Al—In) , an iron-based alloy such as iron-manganese-silicon (Fe—Mn—Si), a magnesium-based alloy, a ceramic-based material (e.g., zirconia, ZrO₂), and/or a polymer-based superelastic material.

A potential advantage of mechanically actuated expansion of envelopes is to reduce the gradient against which gas needs to be pressurized by a compressor. This potentially lowers peak torque demands on the compressor, which may in turn allow reaching a targeted pressure levels with relatively lower power and/or energy requirements. Optionally, actuated expansion “leads” compressor-driven pressurization by a small amount, e.g., by creating a partial vacuum of up to about 1-3 PSI. Once an envelope is sufficiently pressurized from a compressor, mechanical actuation is optionally reversed to increase envelope pressure. This provides a potential advantage by assisting a second stage of compression up to a still higher pressure at which the most highly compressed gas of a pressure control system may be stored, e.g., stored in a hard-walled pressure tank at pressures up to about 150 PSI absolute (for example). Again, this assistance potentially reduces torque requirements on a compressor. With or without use of the mechanical actuators, it is a potential advantage to have a “mid-pressure” compartment, since this divides the overall pressure gradient between tire pressure and maximum stored pressure into two parts, also reducing torque requirements on the compressor or compressors which perform the activity.

Optionally, a partial vacuum larger than 1-3 PSI is created. For example, another potential advantage of using mechanical actuation to expand beyond the pressure equilibrium position is that the device's volume can optionally be rapidly reduced by a sudden release of mechanical holding force—without requiring the exchange of gas through a potentially narrow valve aperture.

Additionally or alternatively, in some examples, an earlier rapid expansion using the pressure of released gas is followed by mechanical actuation which acts to brace the device in an expanded position. This allows the reduced pressure gas to be scavenged and/or released, e. g., to prepare the now relatively evacuated and low-pressure device interior for the option of a later rapid deflation. Optionally, scavenged gas is re-pressurized, potentially allowing it to be released to expand another compartment at a later time. This has a potential advantage for reducing a required capacity of the high-pressure reservoir of the device—e. g., a lower volume and/or a lower compressed storage pressure.

In some examples, pressure control devices are equipped with one or more external release valves which allow gas pressure to be released directly to ambient pressure. It is noted that this entails a particularly significant loss of stored potential energy, and it may be preferable to avoid such releases where feasible. However, in cases where rapid pressure reduction is needed, release to the environment may be acceptable.

Additionally or alternatively, a pressure control device may be provided with a “vacuum reservoir”; that is, a compartment which is evacuated to a pressure significantly below the operating tire pressure, and optionally below ambient pressure, e.g., below 10 PSI, below 5 PSI, or below 1 PSI (these numbers refer to absolute, rather than gauge pressure). The vacuum reservoir is optionally operated by valving, and it may be re-evacuated after use. Optionally, the vacuum reservoir is a consumable emergency device, e.g., it is broken open (for example, shattered) to assist traction during a sufficiently urgent emergency braking maneuver.

Some examples of tire pressure control devices are provided with one or more valves through which their pressurized gas reserves (one or both of the expandable envelopes and the pressure tanks) can be released directly into the main pressurized volume of the tire. Optionally, such devices are provided with one or more pumps (pressurizing pumps) which operate to re-pressurize released gas when a pressure reduction is appropriate, and/or which operate after a tire's pressure has been increased by filling to supplement and/or re-establish reserves of pressurized gas.

As noted: in some examples, re-pressurization is performed in stages. In some examples, a volume contained within one or more expandable envelopes is pressurized to an intermediate pressure above the inflation pressure of the tire (e.g., the pressure immediately behind the wall of the tire). This may be done by actuation of devices which squeeze the expandable envelope volume (e.g., from within or from the outside), and/or by operation of a cycling gas compressor which repeatedly accepts small portions of relative low pressure gas, compresses them, then release them into the envelope volume. The volume inside one or more of the pressure tanks is then pressurized to a higher pressure still, starting from this intermediate pressure. Additionally or alternatively, in some examples, staged compression uses one or more cycling gas compressors.

Pressure control devices optionally operate with any suitable combination of gas pressurization from (mid-pressure) envelopes to (high-pressure) hard-walled tanks, release of pressure in the other direction, gas de-pressurization from mid-pressure envelopes to lower-pressure “vacuum tanks”, gas release to/pressurization from the main pressurized volume of the tire, and gas release to/pressurization from the ambient pressure of the surrounding environment. In some examples, devices use external sources of high pressure gas to restore (at least in part) their high-pressure reservoirs.

### Pressurizing Gas Reserves and Sources

On relatively long-term time scales, some tire pressure control devices of the present disclosure may be considered to act as buffers for tire pressure losses. However, this mode of operation may eventually lead to a need for maintenance operations which restore the pressurized air state of the vehicle's system overall.

Within the limits of their stored gas reservoir capacity and/or movement range of mechanical expansion, devices may expand and/or release gas (e.g., gradually, on average) as tire pressure decreases due to normal pressure losses over time. Without active pumping (that is, without operation of a pressurizing pump), a device may eventually reach the end of its pressure reserves, and/or the limits of its ability to expand its internal volume further. By remote signaling indications, vehicle operators, maintainers and/or automated maintenance systems can be informed about the reserve state of a vehicle's pressure management devices. When tires are eventually re-pressurized, the pressure control devices may reset, e.g., return to an appropriate lower volume, and/or refill their reserves.

In some examples, the “reset” may comprise recompressing gas within the device back to a high pressure (e.g., using one or more pressurizing pumps), and/or reversing mechanically supported volume increases. In some examples, tire pressure control devices use a compressor to compress gas from the main pressurized volume of the tire to re-establish their reserves. In such examples, the tire may be deliberately over-pressurized upon initial filling, to provide enough gas for the device to suitably refill its reserves. It should be noted that these modes of gas reserve self-restoration optionally operate without use of any direct connection of external pressurized gas to the tire pressure control device itself.

Additionally or alternatively, in some examples, tire pressure control devices themselves act as the initial recipient of inflation gas; e.g., shunting gas from a main tire inflation valve (e.g., a Schrader valve) to their internal reservoir or to the main pressurized volume of the tire as appropriate. In some examples, an external source of re-inflation gas is operated at a higher pressure than is needed for the main pressurized volume of the tire (and/or operated with a higher target pressure), and this higher pressure assists in the refilling of the high-pressure reserves of the pressure control devices. For example, the higher pressure is optionally at or near the level of the high-pressure reserves, e.g., up to about 150 PSI (absolute pressure). Optionally, devices perform additional compression as necessary to raise pressure to storage pressure. Once reserves are full, the device optionally rejects further filling. Optionally, the device shunts pressurizing gas to the main pressurized volume of the tire at any suitable stage—before, during, and/or after reserve refilling.

In some examples, tire pressure control devices are themselves configured to restore net pressure losses, e.g., by compressing gas taken from the ambient environment. It should be understood that this involves establishing valved access to the ambient environment, e.g., via a dedicated valve, and/or by accessing and/or replacing the ordinary inflation valve. For example, the tire pressure control device optionally replaces the standard inflation valve; and stores provided inflation gas for itself, or shunts the inflation gas to the main pressurized volume, according to need. Insofar as power may be used to operate pressurizing pumps, some examples of the present disclosure use energy harvesting as a power source. If directly powered, a slow compression rate of 1 PSI per 2 hours of energy harvesting could be maintained with about 10-15 mW of net power (40 liter tire, ideal conditions, and ignoring efficiency losses). This places self-powered pumping apparently within the capabilities of commercially promoted tire energy harvesting devices.

It should be understood that it is not necessary to assume that the air pump is itself a 15 mW pump; for example, energy harvested over a period of time could be stored (e.g., stored electrically and/or chemically by a battery, supercapacitor, and/or fuel cell), and used to power the pump intermittently as appropriate, potentially with more torque than the pump would develop if operating on average available power. While storage devices for electrical power are potentially subject to degradation over time, their service life is potentially similar in length to the service life of a tire, or longer. Some examples are configured to receive power from external sources such as via an electrical socket or via electrical inductive coupling. It may also be noted that stored compressed gas itself represents a potential power source, not only for rapid regulation of pressure, but optionally also for powering low-demand equipment such as valves and sensors; e.g., directly, or by powering a decompression-operated generator.

### Dynamic Pressure Adjustment

An aspect of some examples of the presently described subject matter relates to the dynamic adjustment of pressure in response to one or more events and/or operator instructions.

In some examples, a pressure control device is configured to sense a present tire pressure (that is, receive an indication of tire pressure), and respond by actions which adjust tire pressure to maintain a targeted pressure as appropriate. For example, a tire may have a slow leak, and the pressure control device operates to raise the pressure to restore a targeted (e.g., manufacturer recommended) inflation level. In another example, tire pressure may vary somewhat as a function of operating temperature, and the pressure control device operates to raise or lower pressure as appropriate.

In some examples, a pressure control device is configured to receive an indication that pressure should be significantly changed due to actual and/or imminent road conditions. For example, a vehicle driver intending to drive off-road may send an indication to the pressure control device via a user interface that tells the pressure control device to reduce tire pressure by a significant proportion (for example about 10% about 15%, about 20%, about 25%, or another proportion of tire inflation pressure). Optionally the pressure control device bleeds gas to ambient atmosphere, and/or moves gas to be stored internally at a higher pressure, resulting in reduced pressure in the main compartment of the tire. Optionally, depressurization occurs as an automatic function of driving state and/or road condition sensing. For example a period of driving associated with large sensed vibrations, larger than normal suspension movements, and/or observed road unevenness (i.e., observed by an imager such as a camera or LIDAR) optionally initiates deflation.

At the end of off-roading, a driver may send to the system another command causing the system to release stored gas back into the main pressure compartment of the tire, and/or pump gas from the ambient environment into the main pressure compartment, restoring a targeted on-road running pressure of the tire. Additionally or alternatively, the system is triggered to restore normal running pressure in response to a change in sensing data associated with driving on normal road conditions.

In some examples, a measured indication of precipitation (or dryness) and/or a user indication of precipitation/dryness is received, and the pressure control device adjusts inflation pressure of the main pressure compartment of the tire to provide an appropriate level of traction, accordingly. This may include, for example, deflation of the tire in response to an indication of precipitation that could reduce road friction; and/or inflation of the tire in response to an indication that the road is dry and clear.

Optionally, the tire inflation level is adjusted in response to a normal dynamic driving condition—for example, speed, straight (highway) driving, or steering. An indication of relatively fast and/or straight driving (e.g., highway driving) is optionally responded to by increasing tire air pressure, which potentially improves fuel efficiency. Conversely, the increase may be reversed when driving returns to lower speeds. An indication of steering is optionally responded to by partial deflation and/or inflation (optionally the same or different at different different tires of the car), which may tend to increase cornering traction, and/or reduce slipping due to a difference in turning radius between different wheels of the vehicle. The change in pressure is optionally restored when steering stops. It may be understood that before these operations can be repeated, there may be a refractory period during which pressure and/or vacuum reserves are rebuilt. The method is potentially most useful when reserved for use with particularly dynamic steering, and/or for pressure control devices which are provided with large electrical power reserves, e.g., stored in the tire or provided from operation of the vehicle.

Optionally, the tire inflation level is adjusted in response to emergency maneuvering. For example, upon receiving an indication of hard braking and/or sudden sharp steering at speed, tire inflation may be rapidly reduced by leaking air into a low pressure compartment, and/or bleeding air to ambient pressure. Optionally, (e.g., after the emergency maneuvering is finished), gas from a high pressure reserve stored by the pressure control device is released into the partially deflated tire to restore at least a portion of normal operating pressure.

### Energy Sources

It should be understood that adjusting tire pressure levels generally requires use of energy. The energy may be made available to the system in the form of previously compressed and/or rarefied gasses; i.e., “pressure reserves” and/or “vacuum reserves”. In some examples, energy is available to the system in the form of stored chemical and/or electrical energy; for example, stored in a battery, supercapacitor bank, and/or fuel cell. Optionally, the pressure control device itself includes such a battery or super capacitor bank (e.g. within the pressurized compartment of the tire). Stored electrical energy is harvested from mechanical motions of the tire wheel assembly, in some examples. Optionally, any suitable number of energy harvesting devices is provided. Although energy harvesting may be from any number of devices, the combined generating power may still be less than 1 W, less than 500 mW, less than 250 mW, or less than 100 mW.

Energy may be available for modifying pressure more or less rapidly depending on the form which it is stored. For example vacuum reserves and pressure reserves may be made available for very rapid use (e.g., achieving significant effects on tire performance within 500 msec, 250 msec, 100 msec, or another sub-second period) by opening valves and allowing gas to flow across pressure differentials. Optionally, one or more flow regulators are provided which allow controlling the rate of gas transfer. The flow regulators may be selected for use according to their settings, and/or settings of the flow regulators themselves are optionally set. For example slew rates of greater than 1 PSI per second may be achieved. Power to detect triggering conditions and/or operate the valves themselves may be provided, e.g., by a battery, supercapacitor bank, and/or fuel cell. Optionally, valve opening is triggered by mechanical sensing (e.g., sensing of sudden rotational deceleration, and/or sensing, e.g., by resonance, of vibrations associated with anti-lock brake system activation).

Battery, supercapacitor, and/or fuel cell reserves may be available for operating a compressor on demand (at least as long a stored electrical power remains available), supplying power according to voltage and current capacity, optionally in ranges of 1 W to 1000 W, but typically (e.g., for smaller reserves) in the range of 1-25 W or 5-50 W. Some pressurizing pumps in this range may have difficulty generating enough torque to generate the full pressure differential between ambient pressure or tire inflation pressure and a nominal 10 bar (150 PSI) full storage pressure. However, compression in stages potentially allows some instances of such limitations to be overcome.

Furthermore, power storage capacity may limit the use time of the compressor, and the compressor itself may be of limited power capacity (e.g., 5-50 Watts). For example, power storage capacity may be less than 1 kJ, less than 5 kJ, less than 10 kJ, or less than 50 kJ. The largest of these values is about equivalent to 12 1.5 V alkaline AA batteries.

Slew rates for pressure changes may be understood as limited by the power capacity of the compressor itself and/or its supply of power. In some examples, there may only be enough energy stored for one use of a capability before energy reserves must be regenerated.

Optionally, electrical power is transferred to the pressure control device (e.g., directly and/or for storage in a battery, supercapacitor bank, and/or fuel cell) from another component of the vehicle; e.g., transmitted to the pressure control device by induction components mounted on and/or in proximity to the tire/wheel assembly. In some examples, within-vehicle power transmission occurs during moving operation of the vehicle. For example, electrical motor-type electrical induction in a coil housed in the tire/wheel assembly may be induced by its movements relative to a magnet mounted adjacent to the tire/wheel assembly. In some examples, within-vehicle power transmission occurs while the vehicle is stationary. Optionally, electrical power is transferred to the pressure control device by a plug-in or inductive power transfer connection operated by a user and/or operating automatically while the vehicle is at a charging station.

In examples with an energy harvesting device located inside the tire, appropriate “stimulation” is optionally applied to the tire even while stationary to allow the energy harvesting device to regenerate electricity. For example, the tire is flexed in the vicinity of the energy harvesting device. In some examples, radiative power transfer (e.g., microwave heating) is used to create a temperature differential which allows generating electrical power by a generator type such as a Peltier device inside the tire.

In some examples, a patch positioned in the interior space of a tire and/or a material domain integrated into the tire wall itself comprises a material selected for its heating in response to dielectric absorption of microwave radiation. For example, certain materials such as CoNi, CoNi@SiO₂, CoNi@SiO₂@TiO₂, and CoNi@Air@TiO₂ are reported to have particularly high microwave absorption ability at relative low thicknesses (e.g., 2.1 mm). Certain nanoparticle preparations may absorb microwave radiation efficiently. Optionally, the heat is used to drive a Peltier device; for example, to generate electricity. Optionally, the heat is used to directly drive a thermal expansion compressor.

In some examples, availability of power reserves (electrical and/or as pressure), and/or access to generated power is used to determine what activities are available to the pressure control device, and/or how activities are performed. For example, power in the form of pressure and/or vacuum reserves may be used only once electrical power nears depletion, but not to the extent of interfering with safety functions. For example, enough vacuum reserve may be retained to allow responding quickly in the event of emergency maneuvering.

It is noted that by reducing the contiguous volume of the main pressured volume of the tire, there is potentially a change introduced in the compliance of the tire under dynamic forces. For example, increase in tire pressure as a function of additional transitory compressing forces experienced during driving may itself increase as the pressure control device increases in volume. This may occur, e.g., in examples for which the pressure control device is internally pressurized above the tire pressure itself, and/or when mechanical actuation is what holds the device in an expanded state. Optionally a balance between gas release directly to the main pressurized volume and volume increase of the device itself is selected to suitably maintain appropriate ride characteristics of the tire over time. Optionally, the device's own rapid-response characteristics are used to help absorb a portion of dynamic load changes on the tire. Optionally, changes in tire characteristics are monitored, and other aspects of the car suspension adjusted appropriately in response (e.g., by modifying actuation characteristics of an electronic suspension system).

### Examples With Drawings

Before explaining at least one embodiment of the present disclosure in detail, it is to be understood that the present disclosure is not necessarily limited in its application to the details of construction and the arrangement of the components and/or methods set forth in the following description and/or illustrated in the drawings and/or given in the Examples. drawings. Features described in the current disclosure, including features of the invention, are capable of other embodiments or of being practiced or carried out in various ways.

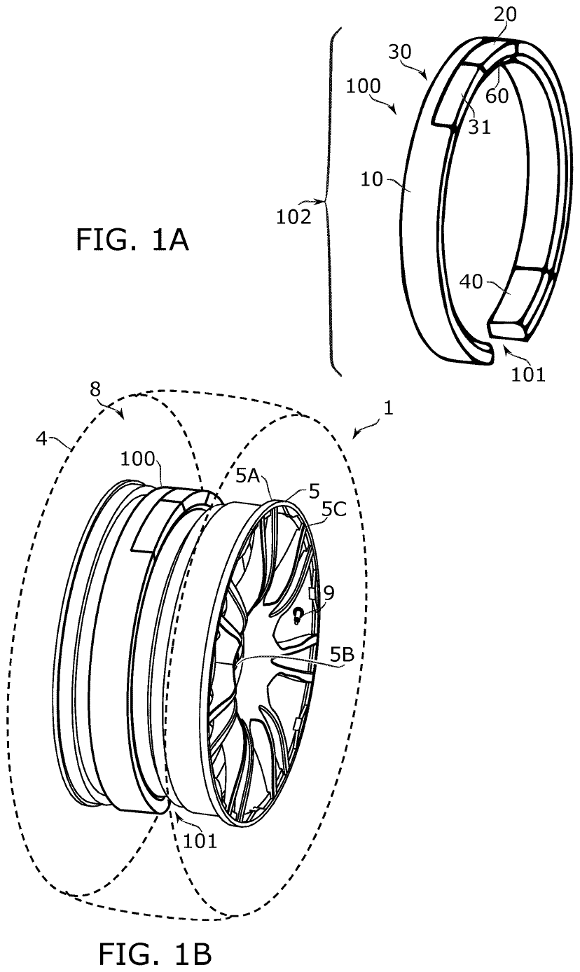

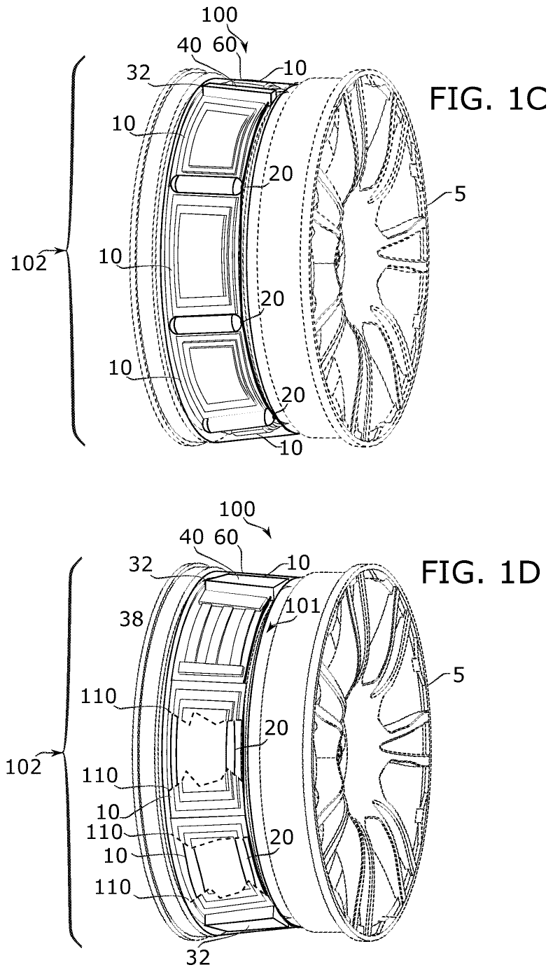

Reference is now made to FIGS. 1A-1B, which schematically illustrate an example of a stand-alone pressure control device 100 for controlling a pressure level and the device assembled in a tire/wheel assembly 1, according to some examples of the presently disclosed subject matter. Tire/wheel assembly 1 may include a wheel 5 and a tire 4. It should be understood that references to the pressure of a “wheel” or “tire” both equivalently refer to pressure within a pressurizeable tire inner space 8 defined, in the case of a tubeless tire/wheel assembly, by the pressurized tire 4 in sealing contact with the wheel 5; e.g., sealing contact along the bead of the tire 4 with the wheel's rim 5A. The hub 5B of wheel 5 is the wheel's center, typically joined to rim 5A via spokes 5C, although hub 5B may be solid and extend to the rim 5A.

A pressure control device 100 for controlling a pressure level in the tire 4 may wholly or at least partially (e.g., some of its components) be positioned for its operation within a tire inner space 8 defined by an outer surface of a wheel 5 and inner surfaces of tire 4. In some examples, pressure control device 100 operates while contained entirely within this space. Preferably, pressure control device 100 comprises a mounting structure 102, which is adjustable (optionally along with adjustments to other components of pressure control device 100) to secure pressure control device 100 to wheel 5 in a rotationally balanced configuration such that pressure control device 100 imparts no significant vibrations to the overall tire/wheel assembly 1 when it rotates. In some examples, the rotationally balanced configuration maintains the tire/wheel assembly within a range of rotational balances which are readily managed by standard wheel balancing procedures.

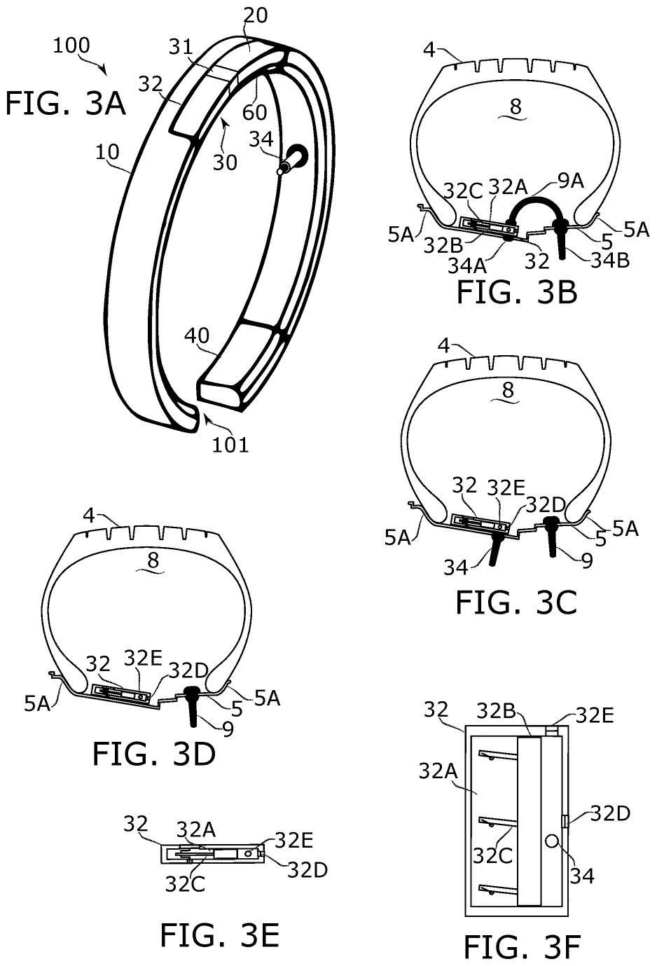

Optionally, pressure control device 100 lacks any direct access to ambient pressure outside of this space; for example as described in relation to FIG. 3D. In some such examples, gas exchange may occur with gas in tire inner space 8. In some examples (again, e.g., as shown in FIGS. 3A-3C), pressure control device 100 has one or more dedicated valves 34A, 34B (distinct from an inflation valve 9 leading directly to the tire inner space 8 of the tire 4) which allow it to release gas directly to the environment, and/or take up gas directly from the environment. In some examples, a dedicated valve 34A is configured to receive gas from an external pressurized source, e.g., a pressurized source which also may serve to pressurize tire inner space 8 directly.

In some examples (for example, as described in relation to FIG. 3B), pressure control device 100 is directly attached to and/or provides a valve 34B in the place on the rim usually dedicated to the tire inflation valve 9. In some examples having valved access to ambient pressure, the body of valve 34A, 34B is the only element of pressure control device 100 which is even partially outside of the pressurized tire inner space 8 of tire/wheel assembly 1, once pressure control device 100 is fully installed.

As should be understood by one skilled in the art, the attachment of pressure control device 100 to wheel 5 shown is given as one non-limiting example of assembling at least some of the components of pressure control device 100 (and optionally all of them) in tire inner space 8 defined by an outer surface of wheel 5 and the inner surfaces of tire 4. In some examples, pressure control device 100 has no contact with tire 4 in its installed position, at least in one of its states (e.g., in a deflated state). This has potential advantages for avoiding interference with the normal functioning of the tire 4.

Mounting structure 102 may itself comprise components of pressure control device 100 with other functions than mounting. In particular, it may be considered to comprise, as suitable, any of the pressure tanks, envelopes, interconnections, and/or housings of pressure control device 100 which it mounts to wheel 5, or any portions thereof. For example, some or all of these elements may be placed in tension when pressure control device 100 is mounted to wheel 5, e.g., belted to it and/or elastically constricted around it. Mounting structure 102 should also be considered to include securing hardware, if used, and optionally interconnecting elements which support the structural integrity of pressure control device 100; e.g., which are placed in tension when pressure control device 100 is secured to wheel 5. It may comprise a covering on any number of sides, e.g., a covering which acts as a belt or portion thereof. In some examples, components of pressure control device 100 are optionally separately anchored to wheel 5, in which case mounting structure 102 may be considered as comprising whatever anchoring fasteners and/or surfaces are involved in the anchoring.

Pressure control device 100 may include one or more inflatable or otherwise variably expanding and contracting envelopes 10, sized and shaped for installation within tire inner space 8. In some examples, the one or more expandable envelopes 10 are made from any expandable material (e.g., an elastomer) and/or structure (e.g., a piston, and/or corrugated and/or folded envelope) configured to change its volume in response to an insertion or extraction of a fluid (e.g., gas).

In a non-limiting example, one or more expandable envelopes 10 are attached to the outer surface of wheel 5, e.g., as illustrated in FIG. 1A.

In some examples, pressure control device 100 further includes one or more pressure tanks 20, in valve-controlled fluid communication with the one or more expandable envelopes 10.

Pressure tank 20 includes, for example, pressurized air, pressurized N₂, pressurized CO₂, or another compressible substance which expands in volume upon decompressing from its storage pressure to a lower pressure; i.e., a pressure at or nearer to the inflation pressure of tire inner space 8. It is not excluded that the pressurized substance is non-gaseous at some pressures, e.g., condensed to a liquid. Substances used in some examples of the present disclosure which are potentially liquid in at least some states of device operation include, R134A, R410A, propane and isobutane. It may be understood that the use of sealed but expandable envelopes is a potential advantage in such examples, in order to allow pressure cycling without loss of an inflation medium with such phase properties. References herein to “gas” should be understood as examples of “fluid” more generally (e.g., optionally including liquid), except insofar as this results in material inconsistency within the context of the disclosure.

In some examples, an operating pressure stored inside pressure tank 20 is higher than the recommended pressure of the tire by at least 10%. For example, if the recommended pressure in the tire is 32 PSI (gauge pressure), the operating pressure in pressure tank 20 may be at least 35 PSI (gauge pressure).

For higher operating pressures, a correspondingly smaller storage volume is optionally provided, and/or overall capacity to modify pressure may be increased. Optionally, the pressure in pressure tank 20 when charged to its full pressure rating is higher; e.g., about 75 PSI, 90 PSI, 120 PSI, 150 PSI, 180 PSI, or another pressure (these are each gauge pressures). It is noted that gauge pressures referred to herein are about 15 PSI (one atmosphere pressure) less than absolute pressure. For example, 150 PSI (gauge pressure) corresponds to an absolute pressure of about 165 PSI, and 30 PSI (gauge pressure) corresponds to an absolute pressure of about 45 PSI. Upon expansion of material which begins and ends in a gaseous phase, gas expansion in volume is by a factor about equivalent to the ratios of storage absolute pressure to expanded absolute pressure; e.g., gas released from a storage absolute pressure of 165 PSI into pressure equilibrium with a tire inner space 8 inflated to an absolute pressure of 45 PSI would expand by a factor of about 3⅔.

In some examples, pressure control device 100 may include a single expandable envelope 10 in fluid connection to pressure tank 20. In some examples, two or more expandable envelopes 10 are fluidly connected to two opposite outlets of pressure tank 20.

Pressure control device 100 may further include one or more controllable mechanisms 30, configured to control the volume of one or more envelopes 10 by at least one of: inflation and deflation of one or more expandable envelopes 10 with gas from pressure tank 20 based on instructions received from a controller 40, and/or using mechanisms actuated in response to pressure indications sensed and/or received by controller 40. Controllable mechanisms 30 are discussed, e.g., with respect to FIGS. 10A-10C. In the non-limiting example illustrated in FIG. 1B, controllable mechanism 30 may comprise or may be at least one controllable valve 31 fluidically interconnecting pressure tank 20 and one or more expandable envelopes 10, for controlling the insertion of pressurized gas from tank 20 into the one or more expandable envelopes 10. In some examples, the valve may be a controllable bidirectional valve. Optionally, pressure control device 100 includes a compressor 32; for example as illustrated and discussed with respect to FIGS. 3A-3D and/or FIGS. 10A-10C.

It should be understood that pressure control device 100 optionally only contains one of the two added pressure compartment types—e. g., only one or more expandable elements 10, or only one or more pressure tanks 20. This optionally applies both to some examples which include a compressor 32 (e.g., as described in relation to FIGS. 3A-3D), and some which do not.

In some examples, controller 40 includes a processor, a memory, and a interface 42 (e.g., a wireless communication unit, operating over a signaling protocol and/or transport mechanism such as as Bluetooth, Zigbee, WiFi, near-field communication, acoustic signal communication, or another signal exchange and/or interfacing method). The memory may store thereon instructions for controlling a pressure level in a tire to be executed by the processor. Optionally, controller 40 is configured using initial parameters 39, optionally including target pressures, and other pressure-related aspects of the vehicle environment in which pressure control device 100. Initial parameters 39 are optionally provided as part of the pressure control device 100 itself, and/or provided via communication interface 42 and uploaded and/or updated as appropriate. Additionally or alternatively, this facility is used to allow upgrades in initial parameters and/or device software.

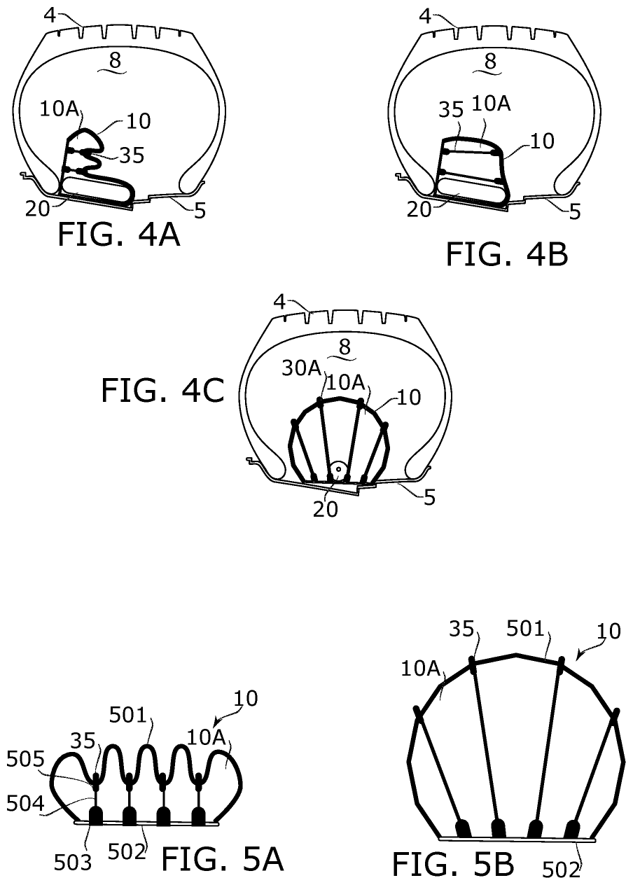

In some examples, pressure control device 100 may further include a sensor configured to generate a signal indicative of the pressure level inside the tire. Alternatively, the communication unit may receive the signal from an external sensor, for example, a sensor of the vehicle, as discussed in detail with respect to FIG. 4 hereinbelow.

In some examples, controller 40 may be configured to receive the instructions for controlling a pressure level in a tire from a user interface 41. For example, the communication interface 42 may receive instructions from a user interface 41 located in the vehicle's dashboard. Optionally, (e.g., for use in maintenance operations) a user interface 41 is provided in a device which connects to the controller 40 in a plugged or near-field mode of operation, e.g., when placed against an outer wall of tire 4, and/or plugged into a signaling port in wheel 5. In some examples, controller 40 is configured to be accommodated in tire inner space 8. Controller 40 is not necessarily digital and/or instruction-oriented in all respects; for example, some aspects of pressure control involving valved release of pressurize gas through a pressure gradient may be actuated mechanically upon exposure to a certain pressure threshold.

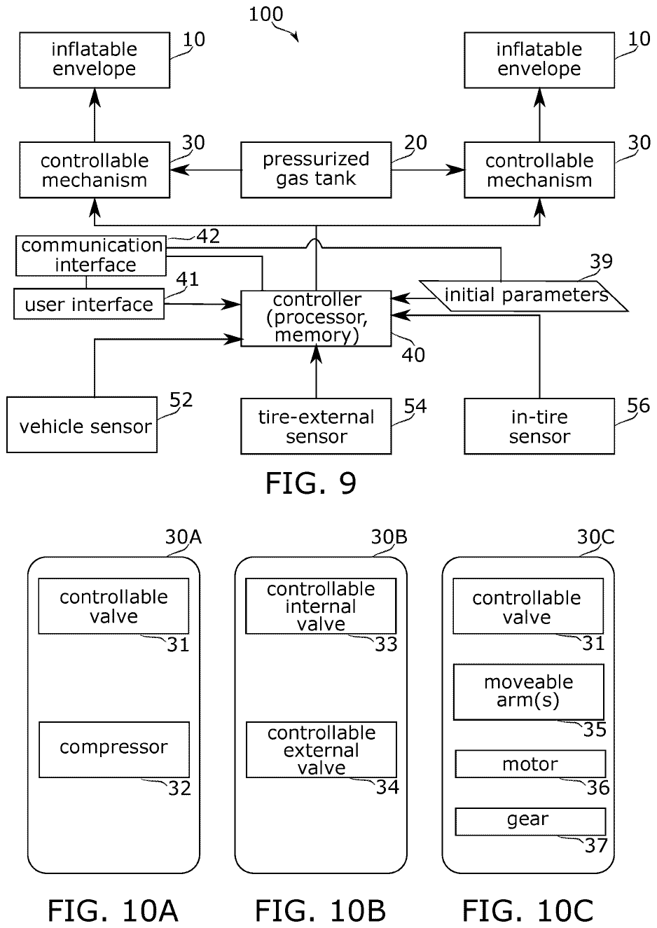

In some examples, pressure control device 100 may include a housing 60 for holding at least one of pressure tank 20, controller 40 and one or more controllable mechanisms 30. In some examples, housing 60 is configured to be accommodated in the tire inner space 8. In some examples, housing 60 may accommodate at least one sensor, for example, in-tire sensor 56 illustrated and discussed in relation to FIG. 9.

It may be noted that the example of FIGS. 1A-1B includes a gap 101. Optionally, this gap allows expanding pressure control device 100 enough to fit over a wheel 5. Pressure control device 100 may then be affixed to wheel 5 by clamping forces; for example, exerted through its own body (e.g., by one or more springs coupled to housing 60), or an additional clamp which secures the ends of pressure control device 100 to each other, for example as described in relation to FIG. 1D.

It is not excluded that tire 4 may be of a design in which pressurization is maintained using an inner tube which defines the pressurized space. Such an inner tube should be understood as distinct from automatically operated elements of the present disclosure; e.g., the inner tube is typically accessed from outside the tire through a protruding inflation valve stem, and/or helps maintains the outer shape of the tire by direct contact with its inner surface.

Reference is now made to Figs. IC-ID, which schematically illustrate other examples of pressure control device 100 for controlling a pressure level in a tire 4, according to some examples of the presently disclosed subject matter.

FIG. 1C and FIG. 1D each show a compartmentalized example, in which a plurality of expandable envelopes 10 are distributed around the circumference of wheel 5. Also shown are a plurality of pressure tanks 20; optionally controlled together or individually by controller 40, which may optionally be housed together with or separately from compressor 32. In the example of FIG. 1C, the pressure tanks 20 are shown relatively small, and positioned in between envelopes 10. In the example of FIG. 1D the pressure tanks 20 are larger in extent (substantially the same in circumferential extent as their corresponding envelopes 10). They are depicted positioned underneath envelopes 10; dotted lines 110 indicate view cutouts of some envelopes 10, allowing pressure tanks 20 to be seen. It should be understood that one or more of pressure tanks 20 are optionally used to “store vacuum”, that is, they may be maintained at a pressure which is lower than the inflation pressure of tire 4.

It should be noted that compressor 32 is optionally oriented so that it extends laterally across the wheel extent, and more particularly, so that its heaviest moving parts such as its piston are oriented to move substantially orthogonal to the radial direction. For example, they are oriented within 15°, within 10° or within 5° of orthogonal to the radial direction. This provides a potential advantage by not inducing large cyclical changes in angular momentum while compressor 32 is in operation. To maintain sufficient compression capacity while maintaining a low profile, Compressor 32 may use a wide-aspect ratio piston (e.g., a piston having a crown with an aspect ratio of 3:1, 5:1, 7:1, 10:1 or another high-aspect ratio), for example as described in relation to FIG. 3E.

Optionally, housing 60 (shown transparently except for its outline) is provided to house and protect any and optionally all of the other components of pressure control device 100. In some examples, housing 60 comprises a metal shell and/or cover which protects components of pressure control device 100 in case of a sudden decompression of tire 4. The housing 60 shown is low-profile; optionally, a higher profile housing 60 is used (to enclose more volume), and/or envelopes 10 are allowed to penetrate housing 60 when they are in an expanded (e.g., inflated) state.

In some examples, each of envelopes 10 operates in conjunction with one or more partner envelopes 10. Sets of partner envelopes 10 are arranged so that they expand and contract in unison without offsetting the center of mass of the overall tire/wheel assembly 1. For example, two partner envelopes are offset by 180° around the circumference of wheel 5, or three partner envelopes are offset by 120° around the circumference of wheel 5.

Optionally, rotational vibration of wheel 5 as a function of actuation (e.g., inflation and/or deflation) of envelopes 10 is monitored; for example, by a sensor 54, 56 in communication with controller 40. In case vibration is detected, controller 40 optionally adjusts actuation of envelopes 10 accordingly (to reduce the vibration). For example, it may actuate one envelope to a different pressure than the other. Optionally, e.g., in cases where controller 40 determines that balance cannot be restored, envelopes 10 are disabled in a rotationally symmetrical group, while other envelopes continue to be operated normally.

In some examples, pressure tanks 20 have a capacity for storing expanding material in the range of about 1-6 liters, and/or taking up about 2%-15% of the overall interior volume of tire 4; e.g., at least 5% of the overall interior volume. For example, a 40 liter tire may be provided with pressure tanks 20 having about 3 liters of capacity, or another capacity in the range of 1-6 liters. In another example, a 100 liter tire is provided with pressure tanks 20 having about 10 liters of capacity.

Capacity of pressure tanks 20 is optionally selected as a larger or smaller amount, depending on the overall interior volume of tire inner space 8 (e.g., proportionally larger or smaller). For examples which do not need maximum deflation capabilities (e.g., deflation by as much as as 25% for off-roading), it may be sufficient to use lower high-pressure capacities. It is noted that for tires with higher recommended operating pressures, a relatively larger volume of high pressure capacity is potentially needed; e.g., if maximum pressure is capped by engineering and/or safety concerns.

In some examples, envelopes 10 have a capacity for storing expanding material in the range of about 1-20 liters. For example, a 40 liter tire may be provided with envelopes 10 having about 10 liters of capacity when expanded, or another capacity in the range of 1-15 liters. Capacity of envelopes 10 is optionally selected as a larger or smaller amount, depending on the overall interior volume of tire inner space 8 (e.g., proportionally larger or smaller). In examples using envelopes primarily to assist staged compression, relatively small volumes may be suitable. However, a larger volume may still provide a potential advantage by allowing larger quantities of gas to be maintained at mid-pressure levels.

In some examples, maximum pressures attained by pressure tanks 20 are significantly greater than maximum pressures attained by envelopes 10. For example, pressure tanks 20 optionally operate at maximum pressures up to 150 PSI, or another pressure; for example as noted in relation to FIGS. 1A-1B. 150 PSI is not an absolute limit; however, it has the potential advantage of remaining within a 10 bar pressure limit for which low-cost componentry is commonly available at the time of filing.

Envelopes 10 optionally operate within about 15 PSI of tire inflation pressure (e.g., 15-45 PSI gauge for a tire inflation pressure of 30 PSI gauge). Optionally, envelopes 10 are operable at higher pressures. For greater pressure differentials, sturdier and/or less elastic envelope design may be selected. For example, for examples in which envelopes 10 operate with relatively low pressure differentials with surrounding gas, volume change is optionally accommodated by substantial elastic stretching and shrinking of the wall material of envelopes 10. In examples using higher pressure differentials, volume changes are optionally accommodated more by folding and unfolding of the envelope walls. For example, envelopes are optionally provided with corrugated walls which telescope and collapse.

In the example of Fig. ID, a section comprising clamps 38 is illustrated. Clamps 38 are optionally implemented as adjustable-length elements which tighten pressure control device 100 against wheel 5. In some examples, clamps 38 are adjustable-length; for example, implemented as one or more cables, belts, or bands. Optionally, two sets of clamps are provided (e.g., the one shown, and another separated by 180° on the opposite side of wheel 5). Suitably adjusting lengths of these clamps potentially assists in maintaining symmetry and wheel balance (a fixed center of angular momentum) after installing pressure control device 100. In some examples, one set of clamps is provided, and balance is achieved by adjusting positions of components of pressure control device 100, and/or by adding weights to pressure control device 100 and/or wheel 5 as appropriate.

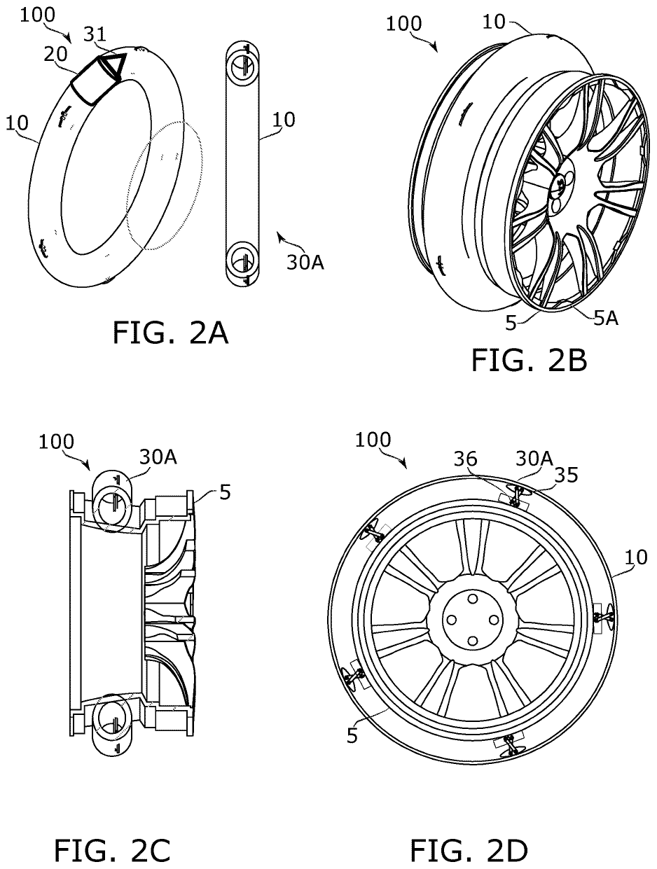

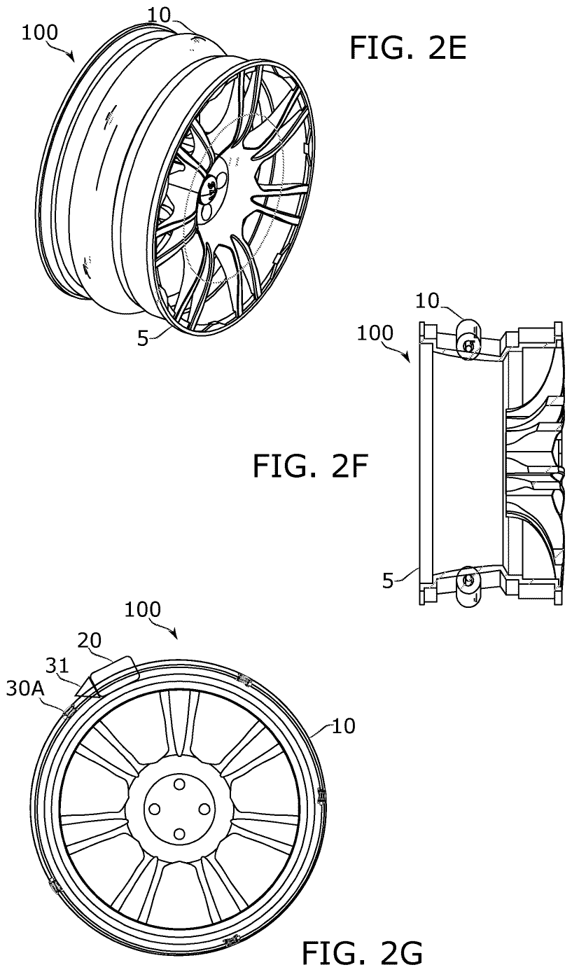

Reference is now made to FIGS. 2A, 2B, 2C, 2D, 2E, 2F and 2G, which schematically illustrate examples of a stand alone pressure control device 100 for controlling a pressure level in a tire, as assembled in a tire/wheel assembly, according to some examples of the presently disclosed subject matter. FIG. 2A includes illustrations of a perspective view and a radial cross-section view of pressure control device 100. FIGS. 2B, 2C, and 2D are illustrations of a perspective view, a radial cross-section view, and a front cross-section view of pressure control device 100 in an inflated state. FIGS. 2E, 2F, and 2G are illustrations of a perspective view, a radial cross-section view, and a front cross-section view of pressure control device 100 in a deflated state.

Pressure control device 100 may include one or more expandable envelopes 10, a compressed pressure tank 20 and one or move valves 31 connected between one or more expandable envelopes 10 and the compressed pressure tank.

Pressure control device 100 may include one or more controllable mechanisms 30A configured to control the volume of one or more envelopes 10 by at least one of inflation and deflation of the one or more expandable envelopes 10; either with gas from the pressure tank 20, or using gas provided by a compressor 32 (not shown in this example) based on instructions received from a controller (40 in FIG. 1B). Controllable mechanisms 30A may include one or more arms 35 powered by one or more motors 36 configured to compress or release pressure from the one or more expandable envelopes 10. In some examples, compressed gas may be provided from pressure tank 20 to inflate envelope 10. In the inflated state (FIGS. 2B-2D) one or more arms 35 are spread, allowing the expansion of expandable envelope 10. In the deflated state (FIGS. 2E-2G) one or more arms 35 are flexed, forcing gas to compress and flow back to pressure tank 20 via valve 31. In some examples, a controller (e.g., controller 40) may control one or more motors 36 to stretch or flex arms 35. Other examples of arms 35 and their operations are also described, for example, in relation to FIGS. 4A-8E.

Pressure control device 100 of FIGS. 2A-2G is optionally fitted to wheel 5 by stretching and/or distorting envelopes 10 enough to slip over rim 5A, and/or by securing free ends of pressure control device 100 to each other after wrapping them around pressure control device 100. Optionally, a portion of the length of pressure control device 100 is cut and discarded as part of fitment.

Reference is now made to FIG. 3A, which schematically illustrates a pressure control device for controlling a pressure level in a tire, according to some examples of the presently disclosed subject matter. Elements of pressure control device 100 of FIG. 3A substantially correspond to those described in relation to FIGS. 1A-1B. For example, it may include one or more expandable envelopes 10 and a compressed pressure tank 20. Via controllable mechanisms 30, pressure control device 100 is configured to control at least one of: the inflation and deflation of the one or more expandable envelopes 10 with gas from the pressure tank 20 based on instructions received from a controller 40.

As shown schematically, controllable mechanisms 30 include a valve 31 (e.g., a bidirectional valve) and at least one compressor 32 fluidically connected between the one or more expandable envelopes 10 and the pressure tank 20.

Additionally or alternatively, controllable mechanisms 30 are depicted with an external valve 34 in fluid connection to the one or more expandable envelopes and the surroundings of the tire (e.g., at ambient air pressure), for optional external releasing of pressurized gas from the one or more expandable envelopes. In some examples, valve 34 inserts to a hole in wheel 5, allowing gas from the one or more expandable envelopes to be released directly to the surroundings of tire 4.

Reference is now made to FIGS. 3B-3D, which schematically illustrate, in cross-section, arrangements of a compressor 32 and one or more valves 34, 34A, 34B, 9 in relation to a pressure control device for controlling a pressure level in a tire, according to some examples of the presently disclosed subject matter. Reference is also made to FIGS. 3E-3F, which schematically illustrate compressor 32 in different cross-sectional views, according to some examples of the presently disclosed subject matter.

Compressor 32 is shown in cross-section as a piston-and-cylinder portion of an air compressor. It should be noted that cylinder 32A along which piston 32B moves is oriented within about 10° of perpendicular to the radial direction from the center of wheel 5. This potentially allows compressor 32 to be run while wheel 5 is turning, potentially without substantially disturbing overall balance of tire/wheel assembly 1, even if piston 32B operates desynchronized from the piston of any other compressor (e.g., a compressor placed 180° opposite, for balance). It should also be noted that in the example shown, the crown of piston 32B has a large aspect ratio. That is, although rather thin in the vertical direction presented by the view of FIG. 3E, the same piston 32B is much wider (e.g., at its crown) in the “top down” or “radial” cross-sectional view of FIG. 3F. This is a potential advantage for maintaining a low-profile fitment within tire inner space 8 (e.g., a profile in which the whole compressor or at least the piston of the compressor does not extend radially beyond rim 5A), while still retaining a reasonable compressor capacity. In some examples, the aspect ratio of piston 32B is at least 5:1, 7:1, 10:1, or another ratio.

Compressor 32 is optionally operated from any suitable power source, for example as described herein. For example, compressor 32 optionally operates on chemical and/or electrical power from a battery, supercapacitor bank, and/or fuel cell. The battery, supercapacitor bank, and/or fuel cell in turn may be charged using any suitable source of power; e.g., one or more energy harvesting devices, or another source of power.

In some examples, compressor 32 operates on a thermal expansion engine principle, in which a volume of material (e.g., aluminum) on a first side of piston 32B (e.g., the side of and optionally in place of shaft 32C as shown in FIG. 3E) is alternately heated and cooled to expand and shrink it. The heating is optionally driven by a direct power input such as temperature changes due to tire operation, or absorbed microwave radiation. Optionally, the heating and/or cooling are driven electrically, e.g., by operation of a Peltier cooling device thermally coupled to the volume of material. Piston 32B is displaced by the volume changes, alternately compressing and releasing compression of gas on the other side. Suitable operation of valves of compressor 32 is used to release compressed gas to compressed gas storage, and/or take in gas from a lower pressure source for the next compression cycle. It is noted that such a compression potentially has a very high compression ratio, although stroke capacity may be small, and cycle time may be slow.

In the example of FIG. 3D, inflation valve 9 is an ordinary tire valve (e.g., a Schroeder valve), leading supplied gas directly into tire inner space 8. Compressor 32 is coupled to gas in tire inner space 8 via a valve 32D, and to one or more compressed gas and/or vacuum reservoirs of pressure control device 100 via valve 32E. Via these couplings, and appropriate operation of valves 32D, 32E, compressor 32 can move gas from any selected lower pressure compartment to a selected higher pressure compartment.

In the example of FIG. 3C, compressor 32 has been provided with its own valve 34, for example as described in relation to FIG. 3A. Otherwise, the situation is as described in relation to FIG. 3D. An optional potential advantage of this situation is that pressure control device 100 has control over valve 34, allowing gas to be vented to ambient pressure upon need (e.g., under control of controller 40), and/or allowing pressure control device 100 to replenish its pressure and/or vacuum reserves directly (e.g., in a way which potentially changes the net gas contents of tire 4). While valve 34 is not necessarily coupled directly to compressor 32, incorporating compressor 32 in the gas circuit allows gas to be moved either with or against the pressure gradient. Optionally, however, one or more bypass routes are provided, such that gas can be vented directly from one or both of envelopes 10 and pressure tanks 20.

In the example of FIG. 3B, valve 9 is replaced with valve 34B, which optionally becomes the primary pressurization port for the tire/wheel assembly 1, i.e., the port to which external inflation pressure is applied. Additionally or alternatively, compressor 32 operates as appropriate to take in supply gas from valve 34B and pressurize it. Venting of pressure (also referred to herein as “bleeding”) is optionally also performed through valve 34B and/or through a dedicated venting valve 34A. Valves leading to one or both of tire inner space 8 and the pressure and/or vacuum reserves of pressure control device 100 are optionally provided (these valves are not labeled in FIG. 3B, but otherwise depicted as in FIG. 3D).

In accordance with the descriptions of FIGS. 3A-3F, it should be understood that pressure control device 100 is optionally able to replenish its internal reserves of pressurized gas and/or reserves of gas under partial vacuum relative to the pressure of tire inner space 8. The flow of gas is optionally according to a pressure gradient (passive), or pumped against the pressure gradient (active). Furthermore, additional to capabilities for managing pressures of its internal reserves, pressure control device 100 is optionally configured to adjust pressure in tire inner space 8; either by exchange of gas with its own internal reserve volumes, or by exchange of gas with ambient pressure. These descriptions, although detailed specifically in relation to FIGS. 3A-3D, should be understood as being optionally applied to any of the examples of pressure control device 100 herein, except as explicitly excluded; or excluded by an incompatibility clear to a person of ordinary skill in the art.

Reference is now made to FIGS. 4A-4B, which schematically illustrate a cross-section of an envelope 10 fitted with a plurality of arms 35 which are operable to compact or expand a lumen 10A of envelope 10, according to some examples of the presently disclosed subject matter. Brief reference is also made to FIG. 4C, which also schematically illustrates a cross-section of an envelope 10 fitted with a plurality of arms 35 which are operable to compact or expand a lumen 10A of envelope 10, according to some examples of the presently disclosed subject matter.

For the sake of visualization, envelopes 10 are shown slightly larger relative to wheel 5 than may be preferred, at least for some circumferential positions. While tire 4 is being placed on wheel 5, a portion of the bead shown at the right may initially seek a position roughly coinciding with the “waist” near the lower right corner of envelope 10 in FIGS. 4A-4B. The narrowing at this waist allows tire 4 to be angled as it is put on to its wheel 5, such that a small amount of stretching suffices to complete placement of the full bead within rim 5A. Accordingly, it may be preferred to reduce the footprint of envelope 10 and/or pressure tank 20 so that there is no interference with tire installation, at least for some circumferential positions. Once tire 4 is installed, interference is potentially less of a problem, and it may be allowable for envelope 10 to expand somewhat into that region. Optionally, pressure control device 100 is configured to be installed on wheel 5 in a laterally compressed, folded, or otherwise distorted and/or reduced-in-size form. Once tire 4 is in place, pressure control device 100 optionally expands itself (e.g., upon inflation of envelopes 10) to extend over a greater lateral extent of wheel 5. Optionally, once it is time to remove tire 4, pressure control device 100 can be forcibly pushed aside again. In some examples, pressure control device 100 has a “folding” mode to get it out of the way; for example, it may comprise a hinged region which can be flipped over by reaching a lever

As also described in relation to other examples, envelope 10 is optionally one of a plurality of envelopes 10 which are part of the same pressure control device 100.

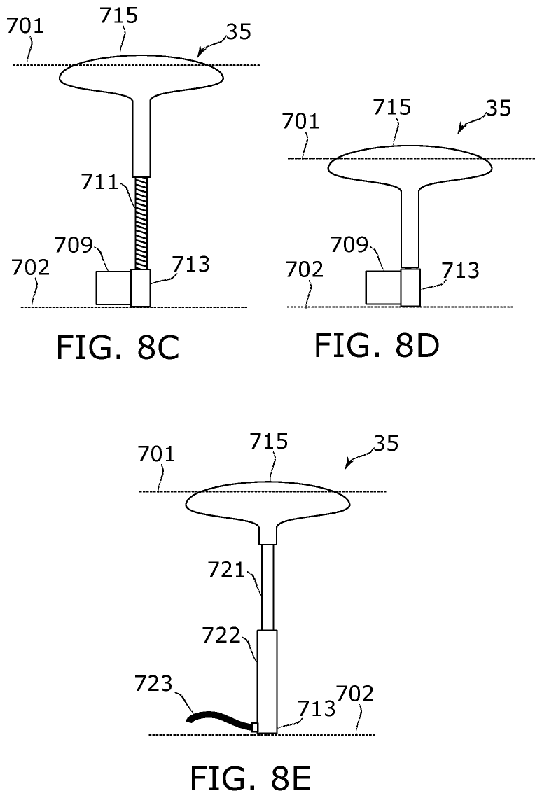

Arms 35 are also referred to herein (equivalently) as “actuators”. They are depicted in schematic form, comprising a base 503, anchor 505, and link 504; e.g., as illustrated in FIG. 5A, which shows a larger version of the controllable mechanisms 30A of FIG. 4C. This general structure may be implemented in various ways, some non-limiting examples of which are described, for example, in relation to FIGS. 8A-8E. Characteristically, actuation acts on link 504 to shorten or lengthen it; adjusting distances between base 503 and anchor 505. The adjusting is used, in some examples, to modify a volume of lumen 10A.

As shown in FIGS. 4A-4B, arms 35 extend laterally, which is again a potential advantage for reducing tire/wheel assembly imbalance due to movements of components in a radial direction.

For example, as shown in FIG. 4A, arms 35 are decreased to their minimum size, collapsing lumen 10A. Lumen 10A is fully expanded in FIG. 4B, as a result of lengthening arms 35. This is also the situation in FIG. 4C, where a different configuration of arms is used, corresponding to the configuration shown in FIGS. 5A-5B.

As illustrated, each of the examples of FIGS. 4A-4C include pressure tank 20 located within lumen 10A. This is optional; pressure tank 20 is optionally external to lumen 10A. Suitable valving and pressure line linkages are provided to allow lumen 10A to act as a mid-pressure tank for higher pressure pressure tank 20, e.g., pressure line linkages including lines leading to valves of one or more compressors 32.

Reference is now made to FIGS. 5A-5B, which each schematically show a cross section of an envelope 10 of a pressure control device 100, according to some examples of the presently disclosed subject matter.

As just discussed, arms 35 comprise a base 503, link 504, and anchor 505. Each anchor 505 attaches to containment membrane 501. Containment membrane 501 is capable of holding a pressure seal, and capable of flexing (optionally with elasticity in its surface area). Containment membrane 501 is able to withstand pressure differences across it according to the pressures it is intended for use with, e.g., as described in relation to envelopes 10 of FIGS. 1C-1D, the overview, and/or elsewhere herein. In the example shown, each base 503 connects to a baseplate 502, but that is not required in all examples; for example, an arm 35 may link two portions of what is, in effect, a containment membrane 501, e.g., as shown in FIGS. 2C-2D and 2F-2G. The number of arms 35 shown across the width of plate 502 is an example; optionally there is any number of arms suitable to the strength, stability, and redundancy appropriate to the pressure conditions of the pressure control device 100.

In some examples, the size of lumen 10A, optionally along with its pressure, is adjusted according to a state and/or activity of pressure control device 100. For example, in the state of FIG. 5B, lumen 10A is at its maximum size. Each arm 35 is fully expanded, and containment membrane 501 is expanded. The examples of FIGS. 5A-5B are indicative of states in which gas in lumen 10A is either at roughly the same pressure as the pressure of tire inner space 8, or potentially substantially higher (that is, compressed). It may be understood, furthermore, that with envelope 10 sealed, contraction of arms 35 from the state of FIG. 5B would result in an elevation of pressure in lumen 10A, so that, upon reaching the state of FIG. 5A, the gas in lumen 10A would become relatively compressed. As noted above, this compression may assist in further compression by a compressor 32 to a higher pressure level stored in a pressure tank 20.

It may be noted that in the transition between FIGS. 5B and 5A, arms 35 swivel where their base 503 connects to baseplate 502. This swivel is an optional feature, with the potential advantage of assisting in creating a larger compression ratio, for certain shapes of envelope 10 and/or containment membrane 501.

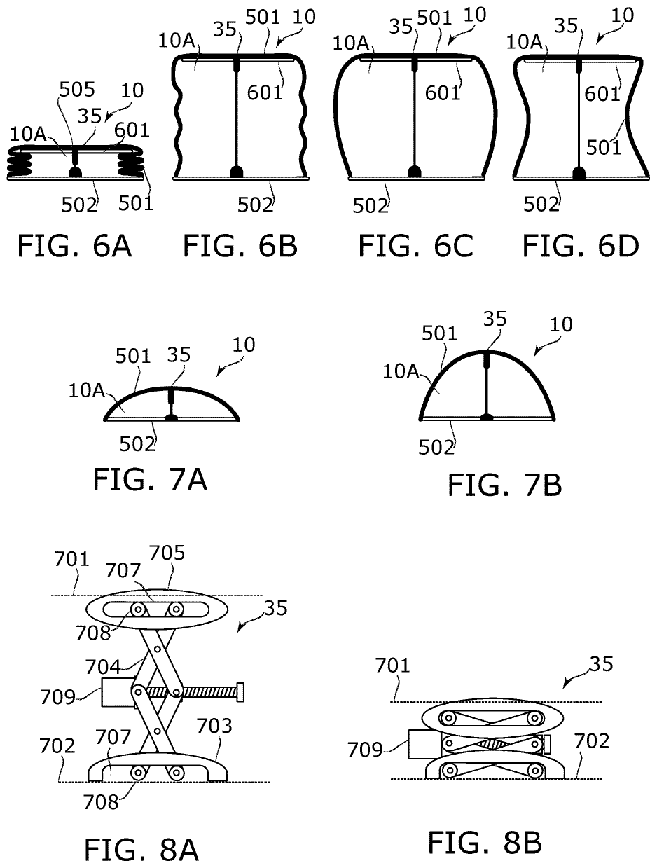

Reference is now made to FIGS. 6A-6D, which each schematically show a cross section of an envelope 10 of a pressure control device 100, according to some examples of the presently disclosed subject matter. In this example, the anchors 505 of arms 35 anchor additionally or alternatively to riser plate 601. Riser plate 601 is optionally stabilized across its width by single arms 35 as shown, but optionally any suitable number; e.g., 1-4 such arms. Riser plate 601 optionally comprises a hoop or portion of a hoop which extends in a circumferential direction around around wheel 5 when pressure control device 100 is installed. Optionally riser plate 601 is one of a plurality of such plates, distributed around the circumference of pressure control device 100, and optionally spaced or overlapping as appropriate to withstand pressure differentials experienced with tire inner space 8. Optionally a radial, tangential, or cross-wise orientation of arm 35 is used.

In FIG. 6A, lumen 10A is collapsed; it may be roughly at an equal pressure with respect to tire inner space 8, or at a higher or lower pressure. To resist pressure differentials, the folded side regions of containment membrane 501 are optionally braced, e.g., cross-braced horizontally, or otherwise constrained from free movement.

In FIG. 6B, lumen 10A is roughly at an equal pressure with tire inner space 8. In FIG. 6C, lumen 10A is over-pressurized, and in FIG. 6D, lumen 10A is under-pressurized. It may be understood, for example, that with lumen 10A sealed in the state of FIG. 6A at a pressure equivalent to that of tire inner space 8, its expansion to the state of FIG. 6D results in a relative vacuum. The state of FIG. 6C could arise, for example, by release of gas pressure from pressure tanks 20, and/or due to pumping by compressor 32.

Reference is now made to FIGS. 7A-7B, which each schematically show a cross section of an envelope 10 of a pressure control device 100, according to some examples of the presently disclosed subject matter. In these examples, containment membrane 501 comprises a stretchable elastic, e.g., a rubber polymer. Again, just one arm 35 is shown across, but an other number is optionally used. The example of FIG. 7A is a collapsed case; the example of FIG. 7B is an expanded case.

Reference is now made to FIGS. 8A-8E, which illustrate examples of arms 35 used with a pressure control device 100, according to some examples of the presently disclosed subject matter.

The example of FIGS. 8A-8B comprises a scissors-jack 700, in which a telescoping arrangement of crossed bars 704 acts as a link 504 between anchor 705 and base 703. Lines 701, 702 respectively represent a containment member and a base to which anchor 705 and base 703 are attached.

By approximation of two horizontally adjacent ends of each pair of crossed bars, other pairs of corresponding ends are brought closer together as well, resulting in the overall extension of scissors-jack 700, e.g., as shown in FIG. 8A. Bar ends 708 slide through slots 707 of base 703 and anchor 705. With greater separation, scissors-jack 700 collapses, e.g., to the configuration of FIG. 8B. Motive force is provided, in some examples, by motorized lead screw 709 (power connections not shown), which attaches to midpoint ends of crossed bars 704.

Additionally or alternatively, motive force is provided by another mechanism; for example, a hydraulic or pneumatic mechanism is used, e.g., as described in relation to FIG. 8E. A scissors-jack has a potential advantage for actuation speed, insofar as a relatively small movement generated at lead screw 709 may produce relatively greater distancing of anchor 705 from base 703. However, corresponding loss of mechanical advantage may reduce the maximum pressure differential against which scissors-jack 700 can perform work, depending on other design parameters such as screw pitch, pressure cylinder diameter, and/or maximum actuation pressure.

The example of FIGS. 8C-8D comprise screw adjustment 710, in which a lead screw 711 is rotated by motor 712 to change a distance of anchor 715 from base 713. This arrangement, relative to that of FIGS. 8A-8B, illustrates a trade-off which potentially increases mechanical advantage (at least for the same screw pitch) while potentially losing actuation speed advantages of scissors-jack 700.

The example of FIG. 8E replaces lead screw 711 with hydraulic or pneumatic piston 721 and hydraulic or pneumatic cylinder 722, actuated via hydraulic or pneumatic conduit 723. It may be understood that a similar hydraulic or pneumatic mechanism is optionally provided for use with a scissors-jack arrangement. A hydraulic or pneumatic mechanism has a potential advantage for rapid restoration of pressure equilibrium, since removing hydraulic or pneumatic pressure leaves the hydraulic or pneumatic cylinder and piston free to move with respect to each other.

A lead screw mechanism may optionally be given a quick release capability as well; e.g., in the form of a thread element that disengages by expansion, but this potentially increases complexity and/or susceptibility to wear of the lead screw. Other examples of arms optionally include arrangements using cables to link anchors and bases. For bidirectional operation, a dual arrangement may be implemented, e.g., to accommodate both uses pulling open against relative vacuum, and uses pulling closed against internal pressure. In some optional examples, a superelastic and/or shape changing material (e.g., nitinol) is used to mechanically drive envelope adjustments. It is noted that where temperature changes are used to drive shape changes, such examples should select transition temperatures outside of the expected operating range of the pressure control device 100 inside the tire 4 of a vehicle. In some examples, a shape-changing material of another type is used; for example, a shape-changing polymer or ceramic. Optionally, a magnetically and/or light-activated shape changing material is used.

Reference is now made to FIG. 9, which is a block diagram of pressure control device 100 for controlling a pressure level in the tire according to some examples of the presently disclosed subject matter. Pressure control device 100 may include one or more expandable envelopes 10, pressure tank 20, one or more controllable mechanisms 30 and controller 40. Controller 40 may be configured to control one or more controllable mechanisms 30 to inflate or deflate one or more expandable envelopes 10, for example, based on signals indicative of the pressure level inside the tire, received from one or more sensors 52, 54, 56.

In some examples, pressure control device 100 may include at least one in-tire sensor 56 located in tire inner space 8. Sensor 56 may directly measure the pressure inside tire inner space 8. For example, sensor 56 may be a pressure sensor, a temperature sensor, a proximity sensor, an accelerometer (e.g., 3-D accelerometer), an IR/LIDAR sensor, an air-flow sensor (e.g., a pitot tube) and the like. Optionally, sensor 56 is a location-sensing device (e.g., based on GPS, another satellite navigation system, and/or another geo-locating system and/or sensor type such as inertial measurements).

In some examples, location sensors are provided in each tire. Optionally location sensors are placed in communication with a wider network (e.g., the internet and/or a cellular communication network) using a communication interface 42. A potential use of this is as a theft deterrent; e.g., each tire is optionally configured for location reporting, independently and/or through one or more shared communication devices.

In some examples, pressure control device 100 may include an tire-external sensor 54, for example, a sensor attached to the hub of wheel 5 and configured to measure ambient conditions, or the state of the tire. For example, sensor 54 may be a temperature sensor, a speedometer, an accelerometer (e.g., 3-D accelerometer), an IR/LIDAR sensor, an air-flow sensor (e.g. a pitot tube) and the like.

In some examples, controller 40 may receive signals indicative of the pressure level in the tire from one or more sensors 52 of the vehicle. For example, sensors 52 may be selected from, a pressure sensor, a temperature sensor, a speedometer, accelerometer (e.g., 3-D accelerometer), ohmmeter, voltmeter, EM emission detector, and exhaust gases emission detector and the like.

Any of sensors 52, 54, 56 optionally comprises one or more sensors of position, orientation, and/or proximity; for example, a GPS sensor, a MEMS gyroscopic and/or acceleration sensor (e.g., having sensing in 3, 4, 5 or more degrees of motion freedom), or an infra-red, ultrasonic, and/or Hall effect range/proximity detector.

Reference is now made to FIGS. 10A, 10B, and 10C, which are block diagrams of various controllable mechanisms according to some examples of the presently disclosed subject matter.

In some examples, a controllable mechanism 30A may include a valve 31 (e.g., a bidirectional valve) and a compressor 32. Valve 31 may be configured to release pressurized gas from tank 20 into one or more expandable envelopes 10, both illustrated in FIGS. 1A, 2A, 2D, 2G, and 3, in order to increase the pressure in the tire. Compressor 32 may be configured to pump and compress gas from the tire into tank 20, for example, via valve 31 when valve 31 is a bidirectional valve. Compressor 32 may be operated when the pressure inside tire inner space 8 should be reduced. In some examples, controller 40 may control valve 31 and compressor 32.

In some examples, a controllable mechanism 30B may include a controllable internal valve 33 configured to release pressurized gas from tank 20 into one or more expandable envelopes 10, both illustrated in FIGS. 1A, 2B, and 3, in order to increase the pressure in tire inner space 8. Valve 33 may be located between one or more expandable envelopes 10 and tank 20 for controlling the insertion of pressurized gas into one or more expandable envelopes 10.

In some examples, controllable mechanism 30B may include a controllable external valve 34 configured to extract gas from expandable envelope 10. Controllable external valve 34 may be in fluid connection with the one of more expandable envelopes 10 and the surroundings of the tire, as illustrated in FIG. 3, for releasing of pressurized gas from the one or more expandable envelopes 10. In some examples, controller 40 may control controllable internal valve 33 and controllable external valve 34.

In some examples, a controllable mechanism 30C may include one or more arms 35 powered by one or more motors 36 configured to press or release the pressure from the one or more expandable envelopes may include, as illustrated in FIG. 2A-2G In some examples, controller 40 may be configured to control motor 36 to activate one or more arms 35 via one or more gears 37.

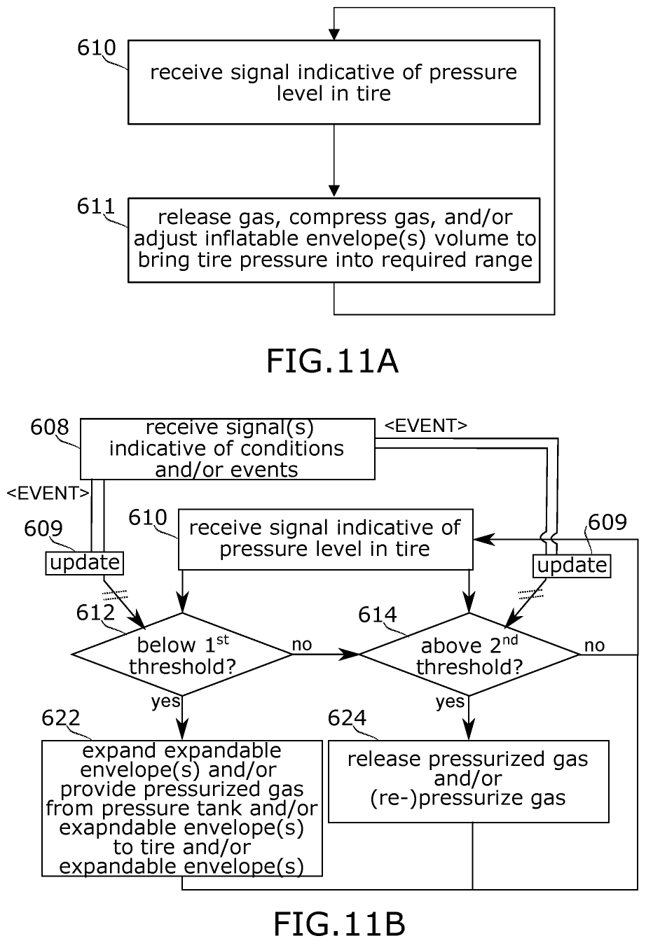

Reference is now made to FIG. 11A, which is a flowchart of a method of controlling a pressure level in a tire of a vehicle, according to some examples of the presently disclosed subject matter. The method of FIG. 11A may be performed by controller 40 and/or an external controller communicating with controller 40.

At block 610, in some examples, a signal indicative of a pressure level in the tire may be received. For example, a pressure measurement of the pressure in the tire may be received from sensor 56. In other examples, the rotational and/or linear speed of the tire/wheel assembly (e.g., the rate of revolution and/or another measurement proportional to the tangential speed at the outer circumference of the tire) may be received from a speedometer, forces acting on the wheel may be received from an accelerometer (e.g., a 3-D accelerometer), an increase in the temperature of the wheel and/or the tire may be received from a thermometer. Any of these may indicate a change (e.g., a reduction) in the pressure level inside tire inner space 8. Some non-limiting examples for the signal indicative of the pressure level may be selected from: pressure, temperature, weight (e.g., vehicle weight and load weight), speed, acceleration (e.g., 3-D acceleration), posture (e.g., orientation), and change in environmental conditions. Optionally, location sensing (e.g., based on GPS, another satellite navigation system, and/or another geo-locating system and/or sensor type such as inertial measurements), is used. For example, location sensing may be used to estimate an altitude (which has a potential effect on gauge pressure), determine a driving status related to a road being traveled along, or for another purpose.

In yet another example, the driver may send controller 40, via a user interface, an indication/command that the correct pressure level in the tire needs to be reduced/increased based on the road conditions. Road conditions themselves (e.g., precipitation, visibility, road surface quality) may be sensed and communicated to controller 40.

At block 611, in some examples, pressure in the tire 4 is adjusted. For example, the volume of the one or more expandable envelopes is controlled to be in a required range. In some examples, controlling the volume of one or more expandable envelopes 10 comprises controlling at least one of inflation and deflation of the one or more expandable envelopes with gas from the pressure tank based on instructions received from a controller. Optionally controlling the volume comprises operating actuators to increase or decrease the volume of the one or more expandable envelopes 10. Additionally or alternatively, gas is released from a pressure tank 20 directly into a tire inner space 8. Additionally or alternatively, gas is removed from a tire inner space 8; e.g., by pumping it into one or more expandable envelopes 10, and/or into one or more pressure tanks 20. Active pumping operations (particularly but not exclusively during vehicle motion) are performed using pumps (e.g., compressors and/or actuators) housed within tire inner space 8 (that is, as part of pressure control device 100). Energy and/or power reserves may be limited, e.g., as also described in relation to blocks 622 and 624 of FIG. 11B.

In some examples, the required range of pressure includes pressures within +25% of the recommended operating pressure of the tire 4, and/or a midpoint of a recommended operating pressure range of the tire 4. In some examples, the flowchart returns to block 610, and space 8 is continuously monitored.

Modification of the operations of block 611 optionally occurs as a function of received signals such as sensor data and/or messages; for example, as described in relation to blocks 608 and/or 609 of FIG. 11B, and/or FIG. 11B more generally.

Reference is now made to FIG. 11B, which is a flowchart of another method of controlling a pressure level in a tire of a vehicle according to some examples of the presently disclosed subject matter. The method of FIG. 11B may be performed by controller 40 and/or an external controller communicating with controller 40.

At block 610, in some examples, a signal indicative of a pressure level in the tire may be received. Block 610 of the method of FIG. 11B may be identical to block 610 of the method of FIG. 11A.

At block 612, in some examples: if the pressure level is below a first threshold level, then at block 622, the one or more controllable mechanisms (e.g., appropriate actuators and/or valves) may be controlled to provide pressurized gas from a pressure tank 20 to one or more expandable envelopes 10. Additionally or alternatively, one or more expandable envelope(s) 10 are compressed by actuators which reduce their volume. For example, if the signal indicative of a pressure level indicates that the pressure level is below 90% of the recommended pressure level, controller 40 may control valve 31 or 33 to provide pressurized gas from tank 20 to one or more expandable envelopes 10. Additionally or alternatively, pressurized gas from pressure tank 20 is optionally released into tire inner space 8 directly. Optionally, gas is released from one or more expandable envelopes 10.

Otherwise, at block 614, in some examples: if the pressure level is above a second threshold level, then at block 624, one or more controllable mechanisms (e.g., appropriate compressors, actuators, and/or valves) may be controlled to release or re-pressurize (using, e.g., electrical power as it is generated and/or from stored reserves) gas from the tire 4 and/or one or more expandable envelopes 10. Gas which is released may be released to ambient pressure, and/or to a lower pressure volume (e.g., a vacuum reserve) within pressure control device 100; e.g., a pressure tank 20 which has been evacuated to a lower pressure than the volume from which gas is being released. For example, if the signal indicative of a pressure level indicates that the pressure level is above the pressure level recommended for traveling on bumpy side-roads, controller 40 may control one or more of compressor 32 (to pump gas from the expandable envelope), external valve 34 (to release gas to the surroundings of the tire), and arms 35 (to reduce the size of expandable envelopes 10, for example, by introducing gas into space 8, which may itself then be vented to atmospheric pressure).

A “pressure release” mode of operation (whether it acts to inflate or to depressurize a tire 4) has the potential advantage of occurring rapidly, e.g., as quickly as the pressure gradient allows gas to flow across opened valve(s). Re-pressurization may comprise operation of one or more compressors, and/or actuators such as arms 35 which operate to reduce volume in one or more expandable envelopes 10. Amounts and/or rates of such re-pressurization are potentially limited by available energy reserves, power generating capacity, and/or power capacity to use energy reserves.

Optionally, at least a portion of re-pressurization occurs without the transfer of an expandable fluid between pressure compartments. For example, one or more envelopes 10 are optionally held expanded at a volume which causes contained pressure to fall below the inflation pressure of tire 4 in the main volume of tire inner space 8. Upon at least partially releasing and/or contracting the actuators holding expansion, the one or more envelopes 10 re-equilibrate to a smaller volume, with a corresponding drop in pressure in tire inner space 8. Depending on how it is carried out, this can be a relatively rapid operation, e.g., potentially even faster than release of fluid through valves, since there is no need for fluid to pass through valve restrictions. If the actuators are suddenly released (e.g., by releasing hydraulic and/or pneumatic pressure), the change may be sudden, e.g., occurring within 100 msec or less. If the actuators are released more gradually (e.g., by rotation of lead screws), the change may be more gradual. Even in this case, however, there is a potential advantage in that operation of the lead screws does not need to perform work against a pressure gradient.

The operations of blocks 622 and/or 624 are optionally modified according to any of several state parameters of pressure control device 100. These include, for example: available reserves of stored electrical power; available reserves of stored pressure (high pressure and/or partially evacuated pressure); present, recent, and/or projected rates of energy harvesting and/or or energy use; and/or availability of other power sources.

Additionally or alternatively, the operations of block 622 and/or 624 are modified in response to received signals indicative of conditions and/or events, e.g., as described in relation to blocks 608 and 609 for modifying the thresholds of blocks 612 and/or 614. Received signals can set appropriate rates of pressure modification, and/or appropriate prioritization of responsiveness to present events vs. retaining reserves for later operations. For example, a vehicle operator may indicate that electrical power reserves should be preserved during a certain trip, in order to ensure that sufficient power for tire deflation will be available for an anticipated period of off-road vehicle operation.

The flowchart returns to block 610, as controller 40 continues monitoring the pressure level.

The operations of block 608, in some examples, comprise optionally asynchronously receipt of signals indicative of conditions and/or events related to vehicle operation, e.g., road conditions, driving state, and/or vehicle operator commands and settings. The signals may be received, e.g., in the form of sensor values, and/or in the form of messages. Upon receiving relevant events, updates 609 are performed, resulting in appropriate updates to the thresholds of blocks 612 and/or 614.

For example, the operations of block 608 may include receiving an indication that the vehicle is returning to driving on a paved road after an off-road excursion, and the updates at block(s) 609 restorative of normal recommended tire pressure thresholds.

Scenarios for dynamic pressure adjustment are also described in the overview section of this specification, including tire leakage, tire temperature, off-road operation, changing conditions of road surfaces (e.g., due to precipitation), high speed driving, steering, and emergency maneuvering (e.g., braking and/or swerving). These descriptions may be understood as providing examples within the scope of the operations of FIGS. 11A and/or 11B.

### General

As used herein with reference to quantity or value, the term “about” means “within ±10% of”.

The terms “comprises”, “comprising”, “includes”, “including”, “having” and their conjugates mean: “including but not limited to”.

The term “consisting of” means: “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

The words “example” and “exemplary” are used herein to mean “serving as an example, instance or illustration”. Any embodiment described as an “example” or “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the present disclosure may include a plurality of “optional” features except insofar as such features conflict.

Throughout this application, embodiments may be presented with reference to a range format. It should be understood that the description in range format is merely for convenience and brevity and should not be construed as an inflexible limitation on the scope of descriptions of the present disclosure. Accordingly, the description of a range should be considered to have specifically disclosed all the possible subranges as well as individual numerical values within that range. For example, description of a range such as “from 1 to 6” should be considered to have specifically disclosed subranges such as “from 1 to 3”, “from 1 to 4”, “from 1 to 5”, “from 2 to 4”, “from 2 to 6”, “from 3 to 6”, etc.; as well as individual numbers within that range, for example, 1, 2, 3, 4, 5, and 6. This applies regardless of the breadth of the range.

Whenever a numerical range is indicated herein (for example “10-15”, “10 to 15”, or any pair of numbers linked by these another such range indication), it is meant to include any number (fractional or integral) within the indicated range limits, including the range limits, unless the context clearly dictates otherwise. The phrases “range/ranging/ranges between” a first indicate number and a second indicate number and “range/ranging/ranges from” a first indicate number “to”, “up to”, “until” or “through” (or another such range-indicating term) a second indicate number are used herein interchangeably and are meant to include the first and second indicated numbers and all the fractional and integral numbers therebetween.

Although descriptions of the present disclosure are provided in conjunction with specific embodiments, it is evident that many alternatives, modifications and variations will be apparent to those skilled in the art. Accordingly, it is intended to embrace all such alternatives, modifications and variations that fall within the spirit and broad scope of the appended claims.

It is appreciated that certain features which are, for clarity, described in the present disclosure in the context of separate embodiments, may also be provided in combination in a single embodiment. Conversely, various features, which are, for brevity, described in the context of a single embodiment, may also be provided separately or in any suitable subcombination or as suitable in any other described embodiment of the present disclosure. Certain features described in the context of various embodiments are not to be considered essential features of those embodiments, unless the embodiment is inoperative without those elements.

It is the intent of the applicant(s) that all publications, patents and patent applications referred to in this specification are to be incorporated in their entirety by reference into the specification, to the same extent as if each individual publication, patent or patent application was specifically and individually noted when referenced that it is to be incorporated herein by reference. In addition, citation or identification of any reference in this application shall not be construed as an admission that such reference is available as prior art to the present disclosure. To the extent that section headings are used, they should not be construed as necessarily limiting. In addition, any priority document(s) of this application is/are hereby incorporated herein by reference in its/their entirety.

1. A device for controlling a pressure level in a pneumatic tire/wheel assembly comprising a wheel and a tire which mounts to a rim of the wheel to define an inner space of the tire between the wheel and the tire pressurized to a first pressure in a first pressurized volume, the device comprising:
one or more expandable envelopes defining a second pressurized volume, and operable to inflate to a second pressure higher than the first pressure;
at least one pressure tank defining a third pressurized volume, pressurizeable to a third pressure higher than the second pressure, and in pressure-controlled fluid communication with the second pressurized volume;
one or more compressors operable to pressurize at least the third pressurized volume;
a controller; and
a wheel mounting structure configured to mount the controller, the one or more expandable envelopes, the at least one pressure tank, and the one or more compressors within the inner space of the tire in a rotationally balanced arrangement;
wherein the controller operates to regulate pressure in the first pressurized volume by initiating exchange of fluid between the third pressurized volume and at least one of the first and second pressurized volumes; and to regulate pressure in the third pressurized volume by initiating exchange of fluid with at least the second pressurized volume.

2. The device of claim 1, wherein the controller operates to regulate pressure in the first pressurized volume by initiating exchange of fluid between the first and second pressurized volumes.

3. The device of claim 1, wherein the controller initiates release of fluid from the third pressurized volume according to a sensed indication that pressure in the first pressurized volume is below a targeted pressure.

4. The device of claim 3, wherein the controller initiates release of fluid from the third pressurized volume into the second pressurized volume.

5. The device of claim 4, wherein inflation of the expandable envelopes increases pressure in the first pressurized volume.

6. The device of claim 1, wherein the controller initiates compression of fluid from the second pressurized volume and into the third pressurized volume.

7. The device of claim 1, wherein the controller initiates compression of fluid from the first pressurized volume into the second pressurized volume, resulting in a decrease of pressure in the first pressurized volume.

8. The device of claim 1, wherein the second pressurized volume is defined by containment membranes of the one or more expandable envelopes, comprising mechanical actuators in contact with the containment membranes, and wherein the actuators move the containment membranes to change the volume of the second pressurized volume, initiated by the controller.

9. The device of claim 8, wherein the controller initiates compression of the expandable envelopes by the actuators, while the controller operates the compressors to pressurize the at least one pressure tank using fluid from within the expandable envelopes.

10. The device of claim 1, wherein the controller regulates pressure in the first pressurized volume by initiating compression or expansion of the one or more expandable envelopes by the actuators.

11. The device of claim 1, further comprising at least one sensor; wherein the controller receives indications from the at least one sensor, and regulates pressure in at least one of the first, second, and third volumes according to the indications.

12. The device of claim 11, wherein the at least one sensor comprises one or more of: a sensor located in the inner space of the tire, a sensor assembled on the tire and external to the inner space of the tire, and sensors of a vehicle comprising the tire/wheel assembly.

13. The device according to claim 9, wherein the at least one sensor is selected from the group consisting of: a pressure sensor, a temperature sensor, a speedometer, an accelerometer, an ohmmeter, a voltmeter, an EM emission detector, a location sensor, and a gasoline emission detector.

14. The device according to claim 9, wherein the at least one sensor comprises a location sensor, and data from the location sensor is transmitted to a communication interface in connection with a network outside of a vehicle to which the device is installed.

15. The device according to claim 1, wherein the controller operates to regulate pressure according to instructions received from a user interface.

16-17. (canceled)

18. The device of claim 1, wherein the wheel mounting structure attaches to a radially outward surface of the wheel.

19. The device of claim 1, wherein the one or more expandable envelopes comprise a plurality of expandable envelopes in pressure-controlled fluid communication with the at least one pressure tank.

20. The device according to claim 1, wherein the wheel includes a waist location sized and positioned to transiently receive a bead of a first side of the tire while the tire is being installed, and the wheel mounting structure positions the device on the wheel, with the waist location unobstructed for a portion of the wheel circumference.

21. The device according to claim 20, wherein the wheel mounting structure positions the device where it is in contact with a bead of a second side of the tire.

22. (canceled)

23. The device of claim 1, including an evacuated pressure tank evacuated to a pressure below the first pressure; wherein the controller operates to reduce pressure in the first pressurized volume by releasing fluid from one or both of the first and second pressurized volumes into the evacuated pressure tank.

24-88. (canceled)
